(19) United States
(12) Patent Application Publication
(10) Pub. No.: US 2026/0302682 A1
(43) Pub. Date: Oct. 1, 2026

(54) HIGH DENSITY, HIGH SPEED CABLE CONNECTOR

(71) Applicant: FCI USA LLC, Etters, PA (US)

(72) Inventors: Neil Franklin Schroll, Mount Joy, PA (US); Christian P. Brandt, York, PA (US); Nathan William Swanger, Dillsburg, PA (US); James J. Muha, Boiling Springs, PA (US); Vysakh Sivarajan, Nashua, NH (US); Michael D. Long, Hershey, PA (US)

(73) Assignee: FCI USA LLC, Etters, PA (US)

(21) Appl. No.: 19/633,010

(22) Filed: Mar. 30, 2026

Related U.S. Application Data
(60) Provisional application No. 63/780,762, filed on Mar. 31, 2025.
(60) Provisional application No. 63/907,821, filed on Oct. 29, 2025.

(51) Int. Cl. H01R 13/514

(52) U.S. Cl. CPC H01R 13/514

(57) ABSTRACT

A high speed, high density electrical connector. The connector includes a housing with chambers separated by a wall, and modules extending through wall channels. The housing has projections protruding from the wall into a chamber and disposed between modules aligned diagonally. The connector has an organizer disposed in another chamber and configured to align conductors of the modules. The connector has a frame partially disposed in the second chamber and configured to align cables of the modules. A module can have a member shielding cable attachments. The member has a body and a deformable coating selectively disposed on an inner surface of the body to bridge a gap between the body and a cable shield. Such techniques facilitate manufacture of closely spaced cable attachments that each carry a signal with high signal integrity and low crosstalk at 100 GHz or above to support data rates of 224 Gbps and beyond.

### CROSS-REFERENCE TO RELATED APPLICATIONS

The present application claims priority to and the benefit under 35 U.S.C. 119 of U.S. Provisional Application 63/780,762, filed Mar. 31, 2025, titled “HIGH DENSITY, HIGH SPEED CABLE CONNECTOR,” and U.S. Provisional Application 63/907,821, filed Oct. 29, 2025, titled “HIGH DENSITY, HIGH SPEED CABLE CONNECTOR,” the contents of each of which is hereby incorporated herein by reference in its entirety.

### FIELD

This patent application relates generally to interconnection systems, such as those including electrical connectors, used to interconnect electronic assemblies.

### BACKGROUND

Electronic systems are often assembled from multiple subassemblies. The construction and function of the subassemblies varies based on the function of the electronic system. A system, for example, may have subassemblies for processing data, storing data, or communicating data over a network.

Sometimes the subassemblies are joined with electrical connectors. The connectors provide a separable interface such that the subassemblies can be manufactured at different times or in different locations, yet simply assembled into a system. A known arrangement for joining multiple subassemblies is to have one subassembly serve as a backplane. The backplane provides connections between other subassemblies. The backplane may be at the back of an equipment rack with connectors facing into the rack such that when other subassemblies are inserted into the rack connectors on those subassemblies may mate with the connectors on the backplane.

In some systems, a backplane is manufactured as a printed circuit board onto which connectors are mounted. Conducting traces in the backplane electrically connect to signal conductors in the connectors so that signals may be routed between the connectors.

In other systems, connectors of the backplane may be held in a cartridge that provides mechanical support with electrical connections made by cables interconnecting the connectors. Such a configuration, sometimes referred to as a cabled backplane, may be used for high data rates or for large systems that require relatively long signal paths through the backplane to interconnect subassemblies. In comparison to traces within a printed circuit board, cables provide signal paths with high signal integrity, particularly for high frequency signals, such as those above 40 Gbps using an NRZ or PAM4 protocol.

Each cable has one or more signal conductors, each of which is surrounded by a dielectric material. The insulated conductors are in turn is surrounded by a conductive layer. A protective jacket, often made of plastic, may surround these components. The jacket or other portions of the cable may include fibers or other structures for mechanical support.

One type of cable, referred to as a “twinax cable,” is constructed to support transmission of a differential signal and has a balanced pair of signal wires embedded in dielectric material and encircled by a conductive layer. The conductive layer is usually formed using foil, such as aluminized Mylar. The twinax cable can also have a drain wire. Unlike a signal wire, which is generally surrounded by a dielectric, the drain wire may be uncoated so that it contacts the conductive layer at multiple points over the length of the cable.

Cables may be terminated with connectors, forming a cable assembly. The connectors may plug into mating connectors of the subassemblies to be connected. At an end of the cable, where the cable is terminated to a connector, different length segments of the protective jacket, dielectric and foil may be removed, leaving portions of the signal wires and the drain wire (if present) and foil shield exposed at the end of the cable. These conductors may be attached to a connector. The signal wires may be attached to conductive elements serving as mating contacts in the connector. The drain wire or foil shield may be attached to a ground conductor in the terminating structure. In this way, any ground return path may be continued from the cable to the terminating structure.

### BRIEF SUMMARY

In some aspects, the techniques described herein relate to an electrical connector including: a housing including first and second chambers separated from each other by a wall, and a plurality of projections protruding from the wall into the first chamber, the plurality of projections arranged in a first two-dimensional array along a row direction and a column direction perpendicular to the row direction; and a plurality of conductive elements, each of the plurality of conductive elements including a first contact portion extending in the first chamber of the housing, a second contact portion extending in the second chamber of the housing, and an intermediate portion between the first contact portion and the second contact portion, the plurality of conductive elements arranged in a second two-dimensional array along the row direction and the column direction and offset from the first two-dimension array in both the row direction and the column directions such that the plurality of projections separate first contact portions of respective conductive elements aligned in a first direction that are offset from both the row direction and the column direction.

In some aspects, the techniques described herein relate to a wafer for an electrical connector, including: an organizing portion elongated in a column direction and including a plurality of channels, each of the plurality of channels having a cross-section elongated in a first direction oblique to the column direction; and a plurality of modules aligned by the organizing portion, each of the plurality of modules including: a module housing partially disposed in a respective channel of the plurality of channels of the organizing portion and extending beyond the organizing portion in a mating direction, and at least one conductive element each including a first contact portion extending out of the module housing in the mating direction and a second contact portion extending out of the organizing portion in a direction different from the mating direction.

In some aspects, the techniques described herein relate to a module for an electrical connector, including: at least one conductive element including a first contact portion, a second contact portion, and an intermediate portion between the first contact portion and the second contact portion; a cable including an insulative sheath, a conductive layer extending inside the insulative sheath and having an end extending beyond the insulative sheath, and at least one wire at least partially surrounded by the conductive layer having an end extending beyond the end of the conductive layer and attached to the second contact portion of the at least one conductive element at an attachment region; and a conductive member including: a conductive body at least partially enclosing the attachment region, and a conductive, deformable coating on at least a portion of the conductive body and toward the conductive layer of the cable.

In some aspects, the techniques described herein relate to a method for manufacturing a module for an electrical connector, including: forming a conductive body elongated in a mating direction and including a front portion having a first width in a lateral direction perpendicular to the mating direction, a rear portion having a second width in the lateral direction, and a connecting portion between the front portion and the rear portion; and selectively applying a conductive, deformable coating to an inner surface of the rear portion of the conductive member.

In some aspects, the techniques described herein relate to an electrical connector, including: a plurality of cable modules, each of the plurality of cable modules including: a conductive element including: a contact portion; a tail configured for connection to a conductor of a cable; and an intermediate portion between the contact portion and the tail; a housing holding the conductive element with the contact portion exposed, wherein: the housing includes an intermediate portion contacting the intermediate portion of the conductive element and an end wall separated from the intermediate portion of the housing by a region; and a portion of the tail is exposed within the region.

In some aspects, the techniques described herein relate to a cable module, including: a conductive element including: a contact portion; a tail configured for connection to a conductor of a cable; and an intermediate portion between the contact portion and the tail; a housing holding the conductive element with the contact portion exposed, wherein: the housing includes an intermediate portion contacting the intermediate portion of the conductive element and an end wall separated from the intermediate portion of the housing by a region; and a portion of the tail is exposed within the region.

In some aspects, the techniques described herein relate to a cable module, including: a conductive element including: a contact portion; a tail configured for connection to a conductor of a cable; and an intermediate portion between the contact portion and the tail; a housing holding the conductive element with the contact portion exposed and a portion of the tail exposed, the housing including a cable stop holding an insulator of the cable away from the tail and allowing the conductor to extend toward the tail.

In some aspects, the techniques described herein relate to an electrical connector including: a housing including a first chamber, a second chamber and a dividing wall between the first chamber and the second chamber, wherein: the dividing wall includes a plurality of apertures therethrough; the housing includes a top wall with a top surface bounding the second chamber and a bottom wall with a bottom surface bounding the second chamber; and the housing includes opposing grooves in the top surface and the bottom surface; a plurality of wafers, each of the plurality of wafers including: a top edge profiled with a first rail extending into a respective groove in the top wall of the housing and a first surface, adjacent the first rail and adjacent the top surface of the top wall and configured to resist pivoting of a wafer via engagement with the top surface; and a bottom edge profiled with a second rail extending into a respective groove in the bottom wall of the housing and a second surface, adjacent the second rail and adjacent the bottom surface and configured to resist pivoting of the wafer via engagement with the bottom surface.

In some aspects, the techniques described herein relate to an electrical connector, including: a housing having a wall transverse to a cable insertion direction and a cavity extending from the wall to a rear of the housing at a cable insertion side of the housing; and cable wafers within the housing, the cable wafers having frames, wherein: each frame has a length such that the frame extends at least 70% of a distance from the wall to the rear of the housing when the frame is fully inserted; and each frame is configured such that at least one surface of the frame contacts the housing for at least a minimum contact amount from the wall to the rear of the housing when the frame is fully inserted into the housing, wherein the minimum contact amount is 70%.

In some aspects, the techniques described herein relate to an electrical connector, including: a housing having a first tie-bar retention slot extending along a top surface of the housing and a second tie-bar retention slot extending along a bottom surface of the housing, the first and second tie-bar retention slots extending along a direction transverse to a cable insertion direction of the electrical connector; and an array of cable wafers within the housing, the array of cable wafers having tie-bar retention slots aligned with the first tie-bar retention slot and the second tie-bar retention slot.

In some aspects, the techniques described herein relate to a wafer for an electrical connector, including: a frame elongated in a column direction and including a plurality of channels; and a plurality of modules, each of the plurality of modules including a module housing disposed in a respective channel of the plurality of channels of the frame and extending beyond the frame in a mating direction, wherein the frame includes at least one latch at a top and/or bottom of the frame in the column direction, the at least one latch being configured to engage with a corresponding latch retention region of a housing to retain the frame within the housing.

In some aspects, the techniques described herein relate to an electrical connector, including: a housing having an inner wall and a rear side, wherein the rear side of the housing is at a cable side of the electrical connector; and a frame elongated in a column direction and including a plurality of channels, the frame being a unitary structure extending from the inner wall to the rear side; and a plurality of modules within the plurality of channels, each of the plurality of modules including a module housing disposed in a respective channel of the plurality of channels of the frame and extending beyond the frame in a mating direction.

In some aspects, the techniques described herein relate to an electrical connector, including: a housing having a first inner wall extending along a direction transverse to a mating direction and a second inner wall extending along a mating direction; a first plurality of cable wafers within the housing, the first plurality of cable wafers being on a first side of the first inner wall and a first side of the second inner wall; and a second plurality of cable wafers within the housing, the second plurality of cable wafers being on the first side of the first inner wall and on a second side of the second inner wall.

In some aspects, the techniques described herein relate to a module for an electrical connector, including: at least one conductive element including a first contact portion, a second contact portion, and an intermediate portion between the first contact portion and the second contact portion; a cable including an insulative sheath, a conductive layer extending inside the insulative sheath and having an end extending beyond the insulative sheath, and at least one wire at least partially surrounded by the conductive layer having an end extending beyond the end of the conductive layer and attached to the second contact portion of the at least one conductive element at an attachment region; and a conductive member including a conductive body at least partially enclosing the attachment region.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1A is a top, front perspective view of an exemplary electrical connector, according to some embodiments, with cables shown cut away at rear ends of cable assemblies.

FIG. 1B is a rear, bottom perspective view of the connector of FIG. 1A.

FIG. 1C is a front perspective view of the connector of FIG. 1A, showing a mating interface.

FIG. 1D is a partially exploded perspective view of the connector of FIG. 1A, showing a housing separated from wafers of the connector.

FIG. 2A is a front perspective view of the housing of the connector of FIG. 1D.

FIG. 2B is a rear perspective view of the housing of FIG. 2A.

FIG. 2C is a top, front perspective view of a left half of an organizer and a holder of the connector of FIG. 1D looking from the mating interface.

FIG. 2D is a top, rear perspective view of the connector of FIG. 2D, showing the housing and the holder, with other components hidden.

FIG. 3A is a perspective view of a wafer of the connector of FIG. 1D, showing a first side (e.g., right side looking from the mating interface).

FIG. 3B is a perspective view of the wafer of FIG. 3A, showing a second side (e.g., left side looking from the mating interface) opposite the first side.

FIG. 3C is a partially exploded perspective view of the wafer of FIG. 3A, showing an organizing portion and first and second subportions of a holding portion separated from modules.

FIG. 3D is a rear view of the wafer of FIG. 3A.

FIG. 3E is a side view of the wafer of FIG. 3A, with conductive members hidden for the top three modules, inner members hidden for the middle two modules, and a conductive, compliant member and an outer member hidden for the third module.

FIG. 4A is a perspective view of a module of the wafer of FIG. 3C.

FIG. 4B is a partially exploded perspective view of the module of FIG. 4B.

FIG. 4C is a plan view of the module of FIG. 4A, with first and second portions of a conductive member moved in opposite directions.

FIG. 4D is a plan view of an alternative embodiment of a module, with first and second portions of a conductive member moved in opposite directions.

FIG. 5A is a perspective view of conductive elements of the module of FIG. 4B.

FIG. 5B is a perspective view of the conductive elements of FIG. 5A attached with a cable.

FIG. 6A is a perspective view of first portions of conductive members of modules of FIG. 4D before being separated from a lead frame.

FIG. 6B is a plan view of the first portions of FIG. 6A.

FIG. 6C is a partial cross-sectional view of the first portions of FIG. 6A along a line marked “6C-6C” in FIG. 6B.

FIG. 6D is an enlarged view of the first portions of FIG. 6A in a circle marked by “6D” in FIG. 6B.

FIG. 7A is a perspective view of second portions of conductive members of modules of FIG. 4D before being separated from a lead frame.

FIG. 7B is a plan view of the second portions of FIG. 7A.

FIG. 7C is a partial cross-sectional view of the second portions of FIG. 7A along a line marked “7C-7C” in FIG. 7B.

FIG. 7D is an enlarged view of the second portions of FIG. 7A in a circle marked by “7D” in FIG. 7B.

FIG. 8A is a top, front perspective view of an electrical connector, according to some embodiments.

FIG. 8B is a rear, bottom perspective view of the connector of FIG. 8A.

FIG. 8C is a partially exploded perspective view of the connector of FIG. 8A, showing a housing separated from wafers of the connector.

FIG. 9 is a top, side perspective view of a portion of an organizer and a holder of the connector of FIG. 8A, right side looking from the mating interface.

FIG. 10A is an exploded front perspective view of an organizing portion and a holding portion for a wafer of the connector of FIG. 8A.

FIG. 10B is a rear perspective view of the organizing portion and the holding portion of FIG. 10A.

FIG. 11A is a front perspective view of another embodiment of an electrical connector having a housing.

FIG. 11B is a perspective view of the electrical connector of FIG. 11A from the cable side.

FIG. 12A is a side sectional view of the electrical connector of FIG. 11A, sectioned through a wafer of the connector of FIG. 11A with the frame fully inserted, according to some embodiments.

FIG. 12B is a side sectional view of the electrical connector of FIG. 11A, sectioned through a wafer of the connector of FIG. 11A with the frame partially inserted, according to some embodiments.

FIG. 13 is a rear perspective view of the connector of FIG. 11A, partially exploded, illustrating insertion of the tie-bars.

FIG. 14 is a detail perspective view of a top corner of the housing of the electrical connector of FIG. 11A showing a tie-bar repair slot.

FIG. 15A is an end-view from the cable side, with cables cut away, illustrating features of the housing that may provide additional mechanical support.

FIG. 15B is a front perspective view of the housing of the electrical connector of FIG. 11A.

FIG. 16 is a perspective view of a cable wafer, illustrating that the frame may be a single piece.

FIG. 17 is a perspective view of another example of a cable module, according to some embodiments, that may be used in electrical connectors as described herein.

FIG. 18 is an exploded view of the cable module of FIG. 17.

FIG. 19 is a top view of the cable module of FIG. 17 with the cable hidden.

FIG. 20 is a top view of a rear portion of the cable module of FIG. 17 with the cable and shields hidden and signal conductive elements within the overmold shown in phantom, illustrating signal lead frame laser welding tabs overmolded for accurate location.

FIG. 21 is a perspective view of the cable module, with shields and cable hidden.

FIG. 22 is a top view of the cable module of FIG. 17 with shields hidden, showing attachment of conductors of the cable to signal conductive elements of the cable module, with insulator of the cable abutting the housing of the cable module.

FIG. 23 is a top perspective view of the rear of the cable module of FIG. 17 with insulator of the cable abutting the housing of the cable module.

FIGS. 24 and 25 are, respectively, front and rear perspective views of an electrical connector with modules arranged in an 8×10 array, with the cables partially cut away.

### DETAILED DESCRIPTION

The inventors have recognized and appreciated connector design techniques for high density connectors that can support greater bandwidth through high frequency operation and be economically mass produced. Connectors can operate with high signal integrity and low crosstalk at 100 GHz or above. Connectors that can transmit data at 224 Gbps and beyond are used as examples of a connector in which these techniques have been applied. The connectors may have conductor pairs with a center-to-center pitch at their mating ends that approximately matches the center-to-center pitch of twinax cable wires, for example, ranging from 32 AWG to 26 AWG, attached to the conductor pairs at their tail ends.

A high density electrical connector for use with high speed signals may include a housing. The housing may include first and second chambers separated by a wall. The first chamber, for example, may contain all or a portion of the mating interface for the connector. The second chamber may contain subassemblies of conductive elements that terminate in mating contact portions.

The wall between the first chamber and the second chamber may have first channels extending therethrough. In some examples, the channels may be arranged in a two-dimensional array along a row direction and a column direction perpendicular to the row direction.

In some examples, the subassemblies may be or may be formed of modules. Each module may, in some examples, terminate a cable, forming a cable assembly. Each module may include one or more conductive elements configured to carry a signal and, optionally, associated conductive members that serve as shielding and/or ground conductors. The conductive elements may include contact portions. In some examples, there may be at least two contact portions, one serving as mating contacts for mating to another connector and the other serving as a contact portion for making connection to another component, such as a cable.

The modules may extend through the first channels so as to form a two-dimensional array corresponding to the first channels. In some examples, the modules may be configured for carrying differential signals and each module may include a pair of conductors aligned in the first direction. Each conductor may include a first contact portion extending in the first chamber of the housing, a second contact portion extending in the second chamber of the housing, and an intermediate portion between the first contact portion and the second contact portion. The second contact portions of the conductors of the modules may be configured to connect with cables.

In some examples, the housing may be configured to provide an angled mating interface (e.g., with mating ends of pairs of signal conductors aligned along a line that makes an angle between 30° and 70° with respect to a column of pairs). For example, each channel may have a cross-section elongated in a first direction that is offset from both the row direction and the column direction. The first contact portions of the conductors of the modules may form an angled mating interface configured to mate with a complementary component.

The housing may have projections protruding from the wall into the first chamber and disposed between modules aligned diagonally. The projections may form a two-dimensional array that is offset from the two-dimension array of the first channels in both the row direction and the column direction so as to be disposed between modules aligned diagonally. Each projection may have a cross-section elongated in a second direction perpendicular to the first direction so as provide desired insulation between modules aligned diagonally in the first direction and modules aligned diagonally in the second direction. The projections may be configured to physically protect mating contacts extending into the first chamber. Alternatively or additionally, the projections may electrically separate adjacent modules, which may reduce crosstalk at the mating interface. In some embodiments, the projections may comprise lossy material to dampen undesirable interference between modules.

Wafers may have a housing that positions modules in a desired orientation, such as a column. The housing maybe formed in one or more pieces, such as a organizer, near the mating end of the modules, and a holder that supports the rear of the modules and, in some examples, cables terminated to the modules.

An organizer may be disposed in the second chamber of the housing and configured to align the modules with the first channels. In some examples, the organizer may be formed of a lossy material and may alternatively or additionally reduce crosstalk between modules. The lossy material, for example, may be adjacent and electrically coupled to conductive structures that serve as shielding and/or ground conductors. The organizer may include second channels substantially aligned with respective first channels of the wall of the housing. In some embodiments, the organizer may have serpentine sides. Opposing sides of the organizers may have complementary profiles with alternating concave and convex segments. When two organizers are placed side by sides, the convex portions of one organizer may nest within the convex portions of an adjacent organizer. When places side by side, there may be first serpentine gaps between adjacent organizers. For each organizer, the convex segments of the serpentine sides may be adjacent to conductors of individual pairs; and the concave segments of the serpentine sides may be adjacent to a space between the conductors of individual pairs.

In some examples, the subassemblies of the connector may include conductive elements configured to carry multiple signals. Such subassemblies are exemplified by wafers herein. A wafer may contain a linear array of conductive elements carrying respective high speed signals. In examples in which signals are carried by pairs of conductive elements, a wafer may include a linear array of pairs of conductive elements. In some examples, a wafer may be formed from multiple modules. Each module, for example, may contain conductive elements configured to carry one signal with associated conductive members for shielding or carrying an associated ground current. In some examples, a subassembly, such as a wafer may be formed with a holder that holds a plurality of modules. The modules may be held in a wafer in a column and multiple columns may be formed by wafers stacked side-by-side.

A holder may be disposed in whole or in part in the second chamber. A rear of the module may be exposed to the outside of the second chamber and may align cables from outside the connector for attachment to the conductive elements of the modules. The holder may be interlocked to the housing via, for example, complementary features. The holder may include third channels substantially aligned with respect to the second channels of the organizer. The third channels may conform to respective outer surfaces of the cables so as to restrain movements of the cables, which otherwise may lead to undesirable movements of the conductors of the modules to which the cables are attached.

In some embodiments, the holder may include holding portions with serpentine sides and second serpentine gaps between adjacent holding portions. As with the organizers, the convex portions of one organizer may nest with the concave portions of an adjacent holder. One or more bars may connect the holding portions and may be disposed in respective grooves of the housing so as to secure the wafers to the housing.

In some examples, the holding portion may be a molded component, and may, for example, be insulative. In some embodiments, each holding portion may include a first side subportion and a second side subportion engaging the first side subportion at multiple locations so as to form the third channels. In some examples, each side subportion may be a metal member such as a metal sheet that is formed with concave and convex portions. In other examples, the first and second side subportions may be formed of different materials. As a specific example, the first side subportion may be molded with, for example, insulative material and/or lossy material, which may provide mechanical support to the cables in the column direction. The second side subportion may be stamped from a conductive sheet and shaped and sized to cooperate with the first side subportion so as to provide mechanical support to the cables.

In some examples, the organizer may be formed as part of the holder such that the organizer is an organizing portion of the holder. In examples in which the organizer is of the same material as a subportion of the holder, the organizer may be integrally formed with a subportion of the holder. The organizer and a subportion of the holder, for example, may both be molded of lossy material.

Wafers may be formed with multiple modules arranged in columns, held together by the organizer and/or holding portions. These portions may include second channels and third channels aligned in the mating direction of the connector. Such a configuration may enable the cables to be attached to module conductive elements before assembling the modules into the connector, enabling the use of signal conductors with cables of varying lengths. For example, each pair of signal conductors may be attached to a cable whose length and termination depend on its intended connection. In some embodiments, the wafers may be inserted into the second chamber of the housing and secured by inserting the one or more bars through openings of the holder.

Cables may have ends attached to second contact portions of the conductors of the modules. In some embodiments, the conductive members of the modules may substantially surround cable attachment regions so as to shield the cable attachment regions of individual modules and/or mechanically engage with the cable. In examples in which the cable has a cable shield exposed at the end of the cable, the conductive members of the modules alternatively or additionally may electrically engage with the cable shield. In some embodiments, a conductive member may have a conductive body, which may be formed by, for example, stamping and folding a conductive sheet.

In some examples, there may be a gap between the conductive body and the cable shield over some or all of the intended area of overlap. Such a gap may reduce the reliability of the electrical connection. Conductive coating may be used to improve the reliability of the electrical connection between the conductive body and the cable shield. The inventors have recognized and appreciated that when electrical currents move to signal conductor surfaces at higher frequencies, including a conductive ink coating in shielding/ground current conductors for the signal conductors may increase loss in high frequency signal transmission in undesired directions. A conductive ink coating is typically less conductive than commonly plated metals, even at thicknesses described herein, which may be much thicker than commonly plated metals. The increased loss may provide signal integrity or electromagnetic radiation control benefits by, for example, damping resonance and/or adding loss to antenna-like patterns of electrical currents.

In some embodiments, a compliant member may be disposed in the gap so as to connect the conductive body and the cable shield. For example, a compliant member may include an elastomer with conductive particles disposed therein and/or a conductive coating disposed thereon. In some embodiments, the conductive coating may have a thickness in a range of 10 μm to 40 μm, including any value or ranges of value within such range. In some embodiments, the conductive coating may be conductive ink. Optionally, the conductive ink may be a flexible carbon ink.

In some configurations, the gap may be too small to accommodate a compliant member yet too large to effectively couple the conductive body and the cable shield. This problem can arise, for example, when using cables with larger diameters, such as 26 AWG. The inventors have recognized and appreciated that selectively disposing a conductive, deformable coating on an inner surface of the conductive body may electrically connect the conductive body and the cable shield. In some embodiments, the conductive, deformable coating, in an uncompressed state, may have a thickness equal to or greater than the gap between the conductive body and the cable shield. In some embodiments, the conductive, deformable coating may have a thickness in a range of 50 μm to 500 μm, including any value or ranges of value within such range. In some embodiments, the conductive, deformable coating may be a conductive ink. Optionally, the conductive ink may be a silver filled polyester ink.

The inventors have further recognized and appreciated techniques that may promote efficient assembly of an electrical connector and/or improve reliability of the connector once assembled that may be used in a connector with some or all of the features described above. In a connector, for example, in which mating portions of the conductive elements of a connector are inserted through a rear chamber of a housing and through channels through a wall of the housing into a mating interface area, reliability may be enhanced by configuring the housing and/or subassemblies including the conductive elements to resist tilt of the subassemblies during insertion. The housing and/or subassemblies may be configured to constrain motion of the subassemblies during insertion to a direction substantially parallel to the insertion direction of the subassemblies. Such a configuration may reduce damage to the contact portions as they pass through the channels, which may increase reliability of operation of the connector.

In some examples, tilt may be reduced by increasing the length along which edges of the subassembly abut opposing sides of the connector housing bounding the rear chamber.

In a connector with a plurality of modules with a holder, the housing may have channels at the top and bottom into which wafers may be inserted. The channels may resist pivoting in a horizontal direction. The top and/or bottom of the housing may contact the wafer for an extended distance along the cable insertion direction, which may resist pivoting in the vertical direction. By including structural features that resist pivoting, the risk of damage to the protruding conductors due to misalignment during insertion may be reduced.

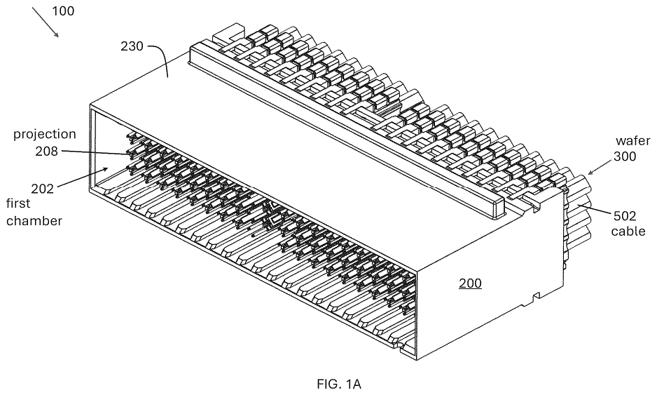

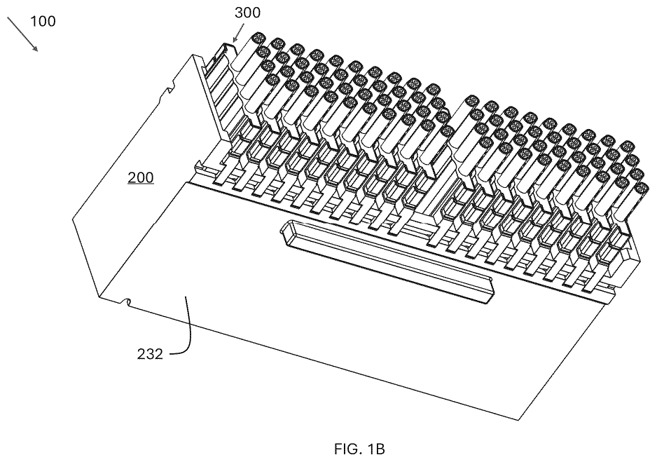

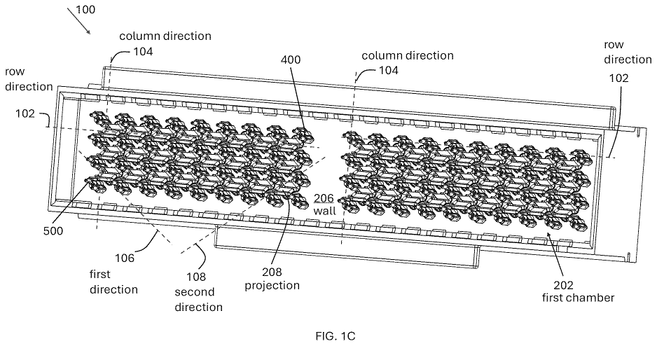

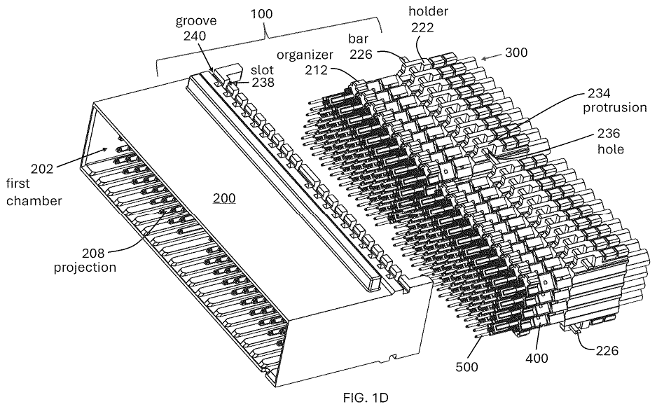

The foregoing principles are illustrated with an example, such as the electrical connector 100 shown in FIGS. 1A-1D. FIGS. 1A-1B show perspective views of one end of a cable assembly at which a connector 100 terminates cables, shown cut away at rear ends of connector 100. FIG. 1C shows a front view of the mating interface of connector 100. Connector 100 may include a housing 200 and wafers 300 held by the housing 200. In this example, wafers 300 are cable wafers as each wafer terminates a plurality of cables. FIG. 1D shows housing 200 separated from wafers 300. Wafers 300 may be aligned in a row direction 102. Each wafer 300 may include modules 400 aligned in a column direction 104, which may be substantially perpendicular to the row direction 102. Each module 400 may include one or more conductive elements 500. In the example illustrated, each module terminates a cable. One or more signal conductors within the cable may be attached to respective conductive elements in the module. Each conductive element 500 may have a mating contact portion configured for mating with a complementary connector. In the example illustrated in FIG. 1D, the mating contact portions of the conductive elements in the modules are shaped as pins. As can be seen in FIG. 1D, there is a pair of mating contact portions per module and the connector in this example is suitable for terminating twinaxial cables in which each cable has a pair of signal conductors.

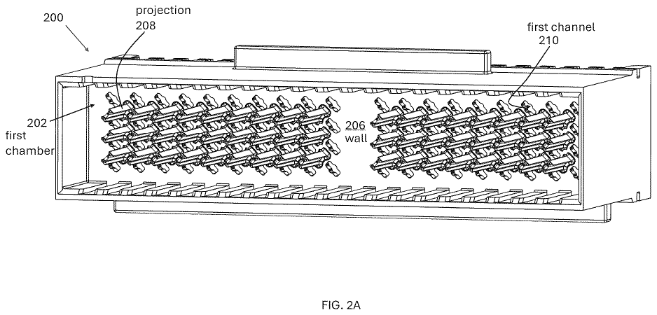

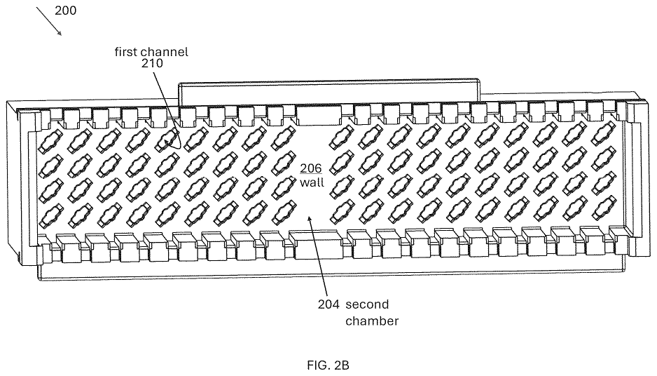

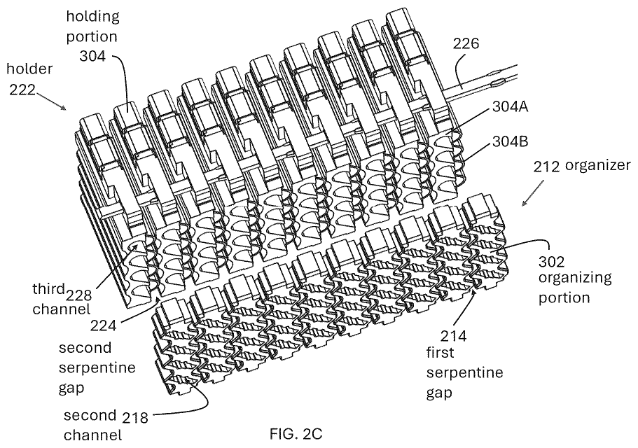

Housing 200 may be configured to provide an angled mating interface for conductive elements disposed close to each other to provide a high density interconnection. As shown in FIGS. 2A-2B, housing 200 may include a first chamber 202 and a second chamber 204 separated from each other by a wall 206. Wall 206 may include first channels 210 arranged in a two-dimensional array along the row direction 102 and the column direction 104. Each first channel 210 may have a cross-section elongated in a first direction 106 that is offset from both the row direction 102 and the column direction 104.

Modules 400 may extend through respective first channels 210 so as to form a two-dimensional array corresponding to the two-dimensional array of the first channels 210. In the illustrated example, each module includes a pair of conductive elements 500 aligned in the first direction 106. For example, the first direction 106 may extend at an angle, for example, ranging 30° and 70°, relative to the row direction. The conductive elements may have mating contacts at one end and those ends may extend through the first channels into the first chamber 202.

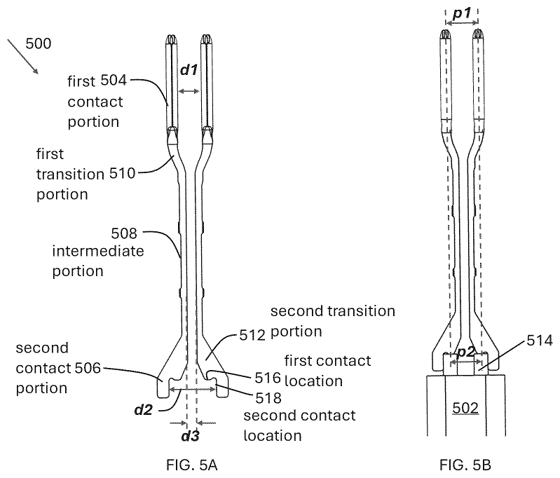

The conductive elements 500 for each module may be configured to provide high-density, high-integrity signal paths and to reduce disruptions (e.g., impedance imbalance) at their ends. In the illustrated example, a pair of conductive elements is configured to provide a signal path for a differential signal. FIG. 5A shows a pair of conductive elements 500. As illustrated, each conductive element 500 may include a first contact portion 504 configured to extend in the first chamber 202 of the housing 200 for mating with a complementary component, a second contact portion 506 configured to be exposed via an opening in the second chamber 204 of the housing 200 such that the second contact portions 506 may be welded or otherwise terminated to conductors of the cables, and an intermediate portion 508 between the first contact portion 504 and the second contact portion 506. Each conductive element 500 may include a first transitioning portion 510 joining first contact portion 504 and intermediate portion 508, and a second transitioning portion 512 joining the intermediate portion 508 and the second contact portion 506.

For the pair, the first contact portions 504 may be separated from each other by a first distance d1. The second contact portions 506 may be separated from each other by a second distance d2. The intermediate portions 508 may be separated from each other by a third distance d3. First transitioning portions 510 of the pair may jog toward each other such that the first distance d1 is greater than the third distance d3. Second transitioning portions 512 of the pair may jog away from each other such that the second distance d2 is greater than the first distance d1. Such a configuration may reduce disruptions at the tail ends where a cable may be attached thereon, by enabling a center-to-center pitch p1 at their mating ends to be approximately match a center-to-center pitch p2 of wires of a twinax cable attached to their tail ends. FIG. 5B shows the pair of conductive elements 500 attached with a cable 502. In some embodiments, cable 502 may be a twinax cable, with diameters of the wires in the cable ranging from 32 AWG to 26 AWG. As illustrated, cable 502 may include a pair of wires 514 attached to second contact portions 512 of respective conductive elements 500 of the pair. Each wire 514 may contact a respective second contact portion 512 at both a first contact location 516 at a tip of wire 514 and a second contact location 518 at a side of wire 514.

Housing 200 may include features configured to reduce interferences between adjacent modules. Referring back to FIGS. 1C and 2A, as illustrated, housing 200 may include projections 208 protruding from wall 206 into first chamber 202. Projections 208 may be configured to align receptacles of a mating connector with the pins of connector. Alternatively or additionally, projections 208 may electrically separate adjacent modules, which may reduce crosstalk at the mating interface. Projections 208 may be arranged in a two-dimensional array along the row direction 102 and the column direction 104. The two-dimensional array of projections 208 may be offset from the two-dimension array of the modules 400 in both the row direction 102 and the column directions 104, such that projections 208 may separate adjacent modules 400 aligned diagonally in the first direction 106. Each projection 208 may have a cross-section elongated in a second direction 108, which may be substantially perpendicular to the first direction 106.

The connector 100 may be assembled from a plurality of modules. In the example illustrated, multiple cables may each be terminated with a module. Connector 100 may include an organizer 212 and/or a holder 222 coupled to the plurality of modules. In the illustrated example, there are multiple organizers 212 and multiple holders 222, each coupled to subsets of the modules. FIG. 2C shows organizers 212 and holders 222 forming the right side of the connector. As can be seen in FIG. 2B, first channels 210 are divided into two groups, with one group on the left side of the connector 100 and the second group on the right side. Each group has multiple columns of first channels. Each column of first channels 210 may receive modules coupled to one of the holders 222 and one of the organizers 212. As can be seen in FIG. 2B, the right half of the connector has ten columns, as does the collection of organizers and holders of FIG. 2C. Though not illustrated for simplicity, the left half of the connector may be formed similarly with holders and organizers for modules with nine columns.

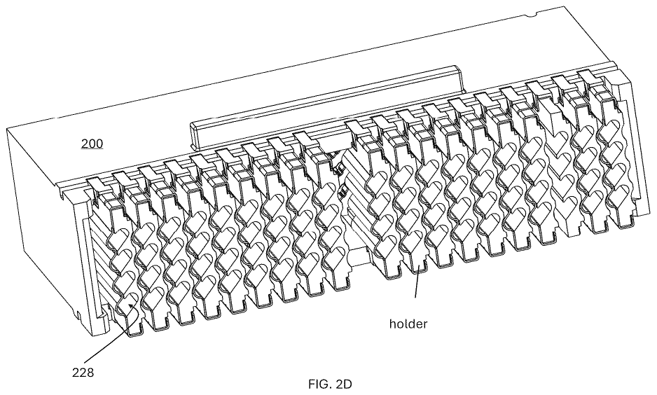

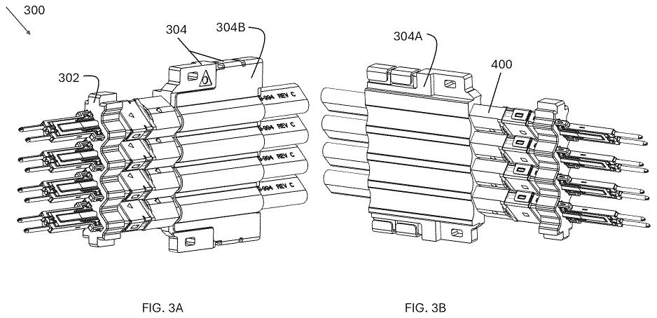

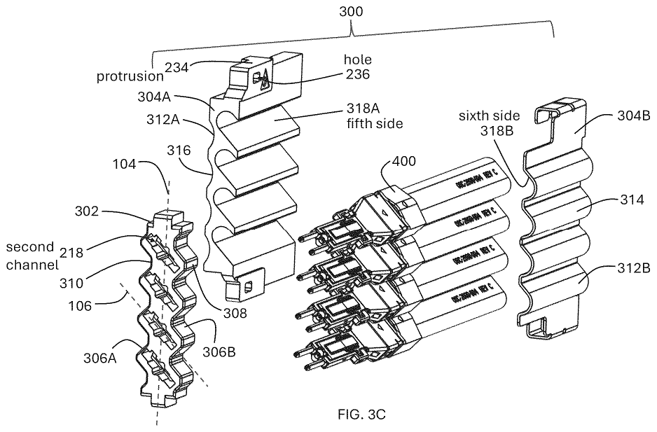

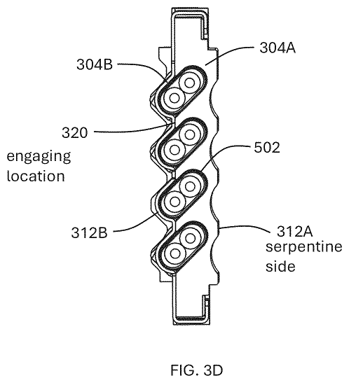

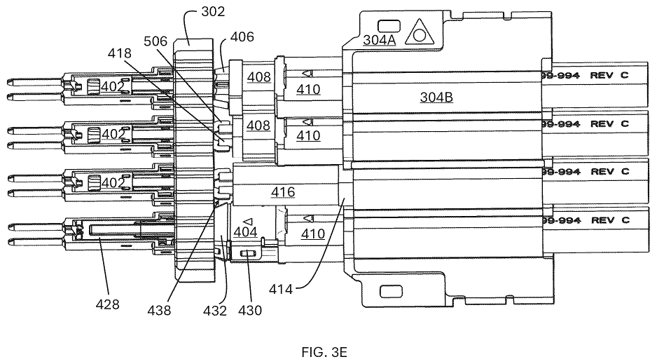

Organizer 212 may have an electrical and/or mechanical function. In some examples, organizers 212 may be made of lossy material, which may reduce crosstalk between modules and/or improve the integrity of signals passing through the connector. Alternatively or additionally, organizers 212 may have a mechanical function. Organizer 212 may be configured to align the modules 400 with the first channels 210 of wall 206 of housing 200. Organizer 212 may be disposed in the second chamber 204 of the housing 200 and abut the wall 206 when modules are fully inserted into housing 200. Organizer may extend substantially from top to bottom of the second chamber of the housing such that, when inserted organizer 212 will be centered between the top and bottom. Organizer 212 may include second channels 218, which may be substantially aligned with respective first channels 210 when organizer 212 is inserted between the top and bottom of housing 200. Organizer 212 may include organizing portions 302 and first serpentine gaps 214 between organizing portions 302 of adjacent organizers. As shown in more detail in FIGS. 3A-3C, the organizing portions 302 may be configured to receive a segment of the modules in which conductive members are exposed on an outer surface of the module. In this way, the organizers may be electrically coupled to conductive members that serve as shielding and/or ground conductors for the modules of a column.

Holder 222 may be configured to align cables 502 attached to the conductive elements 500 of the modules 400. FIG. 2D shows the holders 222 with respect to a rear of housing 200 of connector 100. Cables terminated to the modules are not shown in FIG. 2D, such that channels 228 in which cables are retained are visible. In this example, each of the channels has a cross section that is generally oval, which in this example matches the shape of a twinax cable.

In the example illustrated, holders 222 are partially disposed in the second chamber 204 and partially disposed outside second chamber 204. Each holding portion 304 may include a first side subportion 304A and a second side subportion 304B engaging the first side subportion 304A at locations so as to form the third channels 228. Holders 222 may include third channels 228, which may be configured to conform to respective outer surfaces of cables 502 so as to restrain movements of cables 502. Otherwise, movement of cables 502 may lead to undesirable movement of the conductive elements 500 of the modules 400 to which the cables are attached. Holders 222 may include holding portions 304, second serpentine gaps 224 between adjacent holding portions 304. The holders 222 for multiple columns of modules may be held together with a holding structure instead of or in addition to housing 200. In this example, a bar 226 connects the holding portions 304. In a connector, wafers formed by attaching modules to a holder 222 may be inserted into a housing and a bar, such as 226 may be inserted into a channel in the connector housing and through openings in the holders, or other portion of the wafers, may be inserted into the channel and through the openings so as to lock the wafers in the housing

Alternatively or additionally, housing 200 and holders 222 may include complementary features such that holders 222 can be secured to housing 200. Referring back to FIGS. 1A-1D, housing 200 may include top and bottom walls 230, 232 outside the first and second chambers 202, 204. Wall 206 may be an inner wall joining the top and bottom walls 230, 232. In some embodiments, holder 222 may be configured to be interlocked to both the top and bottom walls 230, 232 of the housing 200. In the illustrated example, each holding portion 304 may include a protrusion 234. Protrusion 234 may be shaped for interlocking with walls 230, 232. In the illustrated example, a protrusion 234 has an L-shaped cross-section. Protrusions 234 may have holes 236, through which bar 226 can extend. One or both of the top and bottom walls 230, 232 can have complementary features for interlocking with holder 222. In the illustrated example, each wall 230, 232 has slots 238 extending in the mating direction of connector 100, and a groove 240 connecting the slots 238 and extending in a lateral direction perpendicular to the mating direction. Each slot 238 may be configured to receive a portion of a protrusion 238 that extends in the mating direction such that another portion of the protrusion 238 that extends in the lateral direction can abut housing 200. Bar 226 may extend through holes 236 of protrusions 234 of holder 222 and be disposed in groove 240 so as to secure the holding portions 304 in position.

One or more components (e.g., projections 208, organizer 212, holder 222) may be lossy and therefore provide damping for undesired resonant modes between adjacent modules 400 and adjacent wafers 300 and limiting resonances within the operating frequency range of the connector, thereby improving signal integrity of signals carried by connector 100. The one or more components may be disposed at disruptive locations. In some embodiments, projections 208 may be lossy to provide damping at the mating interface. In some embodiments, organizer may be lossy to provide damping adjacent cable attachment regions. In some embodiments, holder 222 may be lossy to provide damping adjacent regions where module shields and cable shields connect. Such a configuration may provide desirable signal integrity properties despite closer spacing between the modules 400 and between the wafers 300.

Materials that dissipate a sufficient portion of the electromagnetic energy interacting with that material to appreciably impact the performance of a connector may be regarded as lossy. A meaningful impact results from attenuation over a frequency range of interest for a connector. In some configurations, lossy material may suppress resonances within ground structures of the connector and the frequency range of interest may include the natural frequency of the resonant structure, without the lossy material in place. In other configurations, the frequency range of interest may be all or part of the operating frequency range of the connector.

For testing whether a material is lossy, the material may be tested over a frequency range that may be smaller than or different from the frequency range of interest of the connector in which the material is used. For example, the test frequency range may extend from 10 GHz to 25 GHz or 1 GHz to 5 GHz. Alternatively, lossy material may be identified from measurements made at a single frequency, such as 10 GHz or 15 GHz.

Loss may result from interaction of an electric field component of electromagnetic energy with the material, in which case the material may be termed electrically lossy. Alternatively or additionally, loss may result from interaction of a magnetic field component of the electromagnetic energy with the material, in which case the material may be termed magnetically lossy.

Electrically lossy materials can be formed from lossy dielectric and/or poorly conductive materials. Electrically lossy material can be formed from material traditionally regarded as dielectric materials, such as those that have an electric loss tangent greater than approximately 0.01, greater than 0.05, or between 0.01 and 0.2 in the frequency range of interest. The “electric loss tangent” is the ratio of the imaginary part to the real part of the complex electrical permittivity of the material.

Electrically lossy materials can also be formed from materials that are generally thought of as conductors, but are relatively poor conductors over the frequency range of interest. These materials may conduct, but with some loss, over the frequency range of interest such that the material conducts more poorly than a conductor of an electrical connector, but better than an insulator used in the connector. Such materials may contain conductive particles or regions that are sufficiently dispersed that they do not provide high conductivity or otherwise are prepared with properties that lead to a relatively weak bulk conductivity compared to a good conductor such as pure copper over the frequency range of interest. Die cast metals or poorly conductive metal alloys, for example, may provide sufficient loss in some configurations.

Electrically lossy materials of this type typically have a bulk conductivity of about 1 Siemen/meter to about 100,000 Siemens/meter, or about 1 Siemen/meter to about 30,000 Siemens/meter, or 1 Siemen/meter to about 10,000 Siemens/meter. In some embodiments, material with a bulk conductivity of between about 1 Siemens/meter and about 500 Siemens/meter may be used. As a specific example, material with a conductivity between about 50 Siemens/meter and 300 Siemens/meter may be used. However, it should be appreciated that the conductivity of the material may be selected empirically or through electrical simulation using known simulation tools to determine a conductivity that provides suitable signal integrity (SI) characteristics in a connector. The measured or simulated SI characteristics may be, for example, low cross talk in combination with a low signal path attenuation or insertion loss, or a low insertion loss deviation as a function of frequency.

It should also be appreciated that a lossy member need not have uniform properties over its entire volume. A lossy member, for example, may have an insulative skin or a conductive core, for example. A member may be identified as lossy if its properties on average in the regions that interact with electromagnetic energy sufficiently attenuate the electromagnetic energy.

In some embodiments, lossy material is formed by adding to a binder a filler that contains particles. In such an embodiment, a lossy member may be formed by molding or otherwise shaping the binder with filler into a desired form. The lossy material may be molded over and/or through openings in conductors, which may be ground conductors or shields of the connector. Molding lossy material over or through openings in a conductor may ensure intimate contact between the lossy material and the conductor, which may reduce the possibility that the conductor will support a resonance at a frequency of interest. This intimate contact may, but need not, result in an Ohmic contact between the lossy material and the conductor.

Alternatively or additionally, the lossy material may be molded over or injected into insulative material, or vice versa, such as in a two shot molding operation. The lossy material may press against or be positioned sufficiently near a ground conductor that there is appreciable coupling to a ground conductor. Intimate contact is not a requirement for electrical coupling between lossy material and a conductor, as sufficient electrical coupling, such as capacitive coupling, between a lossy member and a conductor may yield the desired result. For example, in some scenarios, 100 pF of coupling between a lossy member and a ground conductor may provide an appreciable impact on the suppression of resonance in the ground conductor. In other examples with frequencies in the range of approximately 10 GHz or higher, a reduction in the amount of electromagnetic energy in a conductor may be provided by sufficient capacitive coupling between a lossy material and the conductor with a mutual capacitance of at least about 0.005 pF, such as in a range between about 0.01 pF to about 100 pF, between about 0.01 pF to about 10 pF, or between about 0.01 pF to about 1 pF. To determine whether lossy material is coupled to a conductor, coupling may be measured at a test frequency, such as 15 GHz or over a test range, such as 10 GHz to 25 GHz.

To form an electrically lossy material, the filler may be conductive particles. Examples of conductive particles that may be used as a filler to form an electrically lossy material include carbon or graphite formed as fibers, flakes, nanoparticles, or other types of particles. Various forms of fiber, in woven or non-woven form, coated or non-coated may be used. Non-woven carbon fiber is one suitable material. Metal in the form of powder, flakes, fibers or other particles may also be used to provide suitable electrically lossy properties. Alternatively, combinations of fillers may be used. For example, metal plated carbon particles may be used. Silver and nickel are suitable metal plating for fibers. Coated particles may be used alone or in combination with other fillers, such as carbon flake.

Preferably, the fillers will be present in a sufficient volume percentage to allow conducting paths to be created from particle to particle. For example, when metal fiber is used, the fiber may be present in about 3% to 30% by volume. The amount of filler may impact the conducting properties of the material, and the volume percentage of filler may be lower in this range to provide sufficient loss.

The binder or matrix may be any material that will set, cure, or can otherwise be used to position the filler material. In some embodiments, the binder may be a thermoplastic material traditionally used in the manufacture of electrical connectors to facilitate the molding of the electrically lossy material into the desired shapes and locations as part of the manufacture of the electrical connector. Examples of such materials include liquid crystal polymer (LCP) and nylon. However, many alternative forms of binder materials may be used. Curable materials, such as epoxies, may serve as a binder. Alternatively, materials such as thermosetting resins or adhesives may be used.

While the above-described binder materials may be used to create an electrically lossy material by forming a binder around conducting particle fillers, lossy materials may be formed with other binders or in other ways. In some examples, conducting particles may be impregnated into a formed matrix material or may be coated onto a formed matrix material, such as by applying a conductive coating to a plastic component or a metal component. As used herein, the term “binder” encompasses a material that encapsulates the filler, is impregnated with the filler or otherwise serves as a substrate to hold the filler.

Magnetically lossy material can be formed, for example, from materials traditionally regarded as ferromagnetic materials, such as those that have a magnetic loss tangent greater than approximately 0.05 in the frequency range of interest. The “magnetic loss tangent” is the ratio of the imaginary part to the real part of the complex electrical permeability of the material. Materials with higher loss tangents may also be used.

In some embodiments, a magnetically lossy material may be formed of a binder or matrix material filled with particles that provide that layer with magnetically lossy characteristics. The magnetically lossy particles may be in any convenient form, such as flakes or fibers. Ferrites are common magnetically lossy materials. Materials such as magnesium ferrite, nickel ferrite, lithium ferrite, yttrium garnet or aluminum garnet may be used. Ferrites will generally have a loss tangent above 0.1 at the frequency range of interest. Presently preferred ferrite materials have a loss tangent between approximately 0.1 and 1.0 over the frequency range of 1 GHz to 3 GHz and more preferably a magnetic loss tangent above 0.5 over that frequency range.

Practical magnetically lossy materials or mixtures containing magnetically lossy materials may also exhibit useful amounts of dielectric loss or conductive loss effects over portions of the frequency range of interest. Suitable materials may be formed by adding fillers that produce magnetic loss to a binder, similar to the way that electrically lossy materials may be formed, as described above.

It is possible that a material may simultaneously be a lossy dielectric or a lossy conductor and a magnetically lossy material. Such materials may be formed, for example, by using magnetically lossy fillers that are partially conductive or by using a combination of magnetically lossy and electrically lossy fillers.

Lossy portions also may be formed in a number of ways. In some examples the binder material, with fillers, may be molded into a desired shape and then set in that shape. In other examples the binder material may be formed into a sheet or other shape, from which a lossy member of a desired shape may be cut. In some embodiments, a lossy portion may be formed by interleaving layers of lossy and conductive material such as metal foil. These layers may be rigidly attached to one another, such as through the use of epoxy or other adhesive, or may be held together in any other suitable way. The layers may be of the desired shape before being secured to one another or may be stamped or otherwise shaped after they are held together. As a further alternative, lossy portions may be formed by plating plastic or other insulative material with a lossy coating, such as a diffuse metal coating.

Wafers 300 may be formed with multiple modules 400 held in columns by organizing portions 302 and holding portions 304, which have second channels 218 and third channels 228 substantially aligned in the mating direction of connector 100. FIGS. 3A-3B show perspective views of a wafer 300, showing opposite sides looking from the mating interface. FIG. 3C shows a partially exploded perspective view of the cable wafer of FIG. 3A, showing an organizing portion 302 and first and second subportions 304A and 304B of a holding portion 304 separated from modules 400. FIG. 3D shows a rear view of the wafer 300.

Organizing portion 302 may be shaped and sized to support the angled mating interface. As illustrated, organizing portion 302 may include first and second serpentine sides 306A and 306B. Each of the first and second serpentine sides 306A and 306B may include convex segments 308 and concave segments 310. Convex segments 308 may be disposed close to conductive elements 500 of respective modules, while concave segments 310 may be disposed close to spaces between conductive elements 500 of the pairs of individual modules 400. Convex segments 308 of the first serpentine side 306A may face concave segments 310 of the second serpentine side 306B. Concave segments 310 of the first serpentine side 306A may face convex segments 308 of the second serpentine side 306B.

Holding portion 304 may be shaped and sized to support an angled mating interface. In the example illustrated, subportions 304A and 304B are shaped such that, when they are secured to each other, their facing sides cooperate to bound a plurality of openings, each sized to receive and hold a cable. As illustrated, holding portion 304 may include third and fourth serpentine sides 312A and 312B. Each of the third and fourth serpentine sides 312A and 312B may include convex segments 314 and concave segments 316. Convex segments 314 of the third serpentine side 312A may face concave segments 316 of the fourth serpentine side 312B. Concave segments 316 of the third serpentine side 312A may face convex segments 314 of the fourth serpentine side 312B.

In some embodiments, as illustrated in FIGS. 3C-3D, the holding portion 304 may include a first side subportion 304A and a second side subportion 304B. The first side subportion 304A may include the third serpentine side 312A and a fifth side 318A opposite the third serpentine side 312A. The second side subportion 304B may include the fourth serpentine side 312B and a sixth side 318B opposite the fourth serpentine side 312B. The sixth side 318B of the second side subportion 304B may engage the fifth side 318A of the first side subportion 304A at multiple locations 320.

In some embodiments, the first side subportion 304A and the second side subportion 304B may include different materials. For example, the first side subportion 304A may be molded with, for example, insulative material and/or lossy material, which may provide mechanical support to cables 502 in the column direction 104. The second side subportion 304B may be stamped from a conductive sheet and shaped and sized to cooperate with the first side subportion 304A so as to provide mechanical support to cables 502 in the row direction 102. With such a configuration, the metal sheet may provide sufficient force against the cable to hold it in place between subportions 204A and 304B, but may have some give such that the cable is not deformed to an extent that the integrity of signals passing through the cable is materially degraded.

Such a configuration may enable the attachment of cables 502 to conductive elements 500 of modules 400 before assembling modules 400 into wafers 300. Cables, which may be of various lengths, may be attached to conductive elements 500 of different modules 500. For example, each pair of conductive elements 500 may be attached to a cable that has a length and termination at the other end that depends on a desired system configuration. In some embodiments, wafers 300 may be inserted into housing 200, and then locked therein by disposing one or more bars 226 of holder 222.

Referring to FIG. 3E, which shows a side view of wafer 300, with conductive members 404 hidden for the top three modules, inner members 406 hidden for the middle two modules, and conductive, compliant member 408 and outer member 410 hidden for the third module. Second contact portions 502 of the pairs of conductive elements 500 may extend out of organizing portion 302. Second transitioning portions 512 of the pairs of conductive elements 500 may be disposed in respective second channels 218 of organizing portion 302.

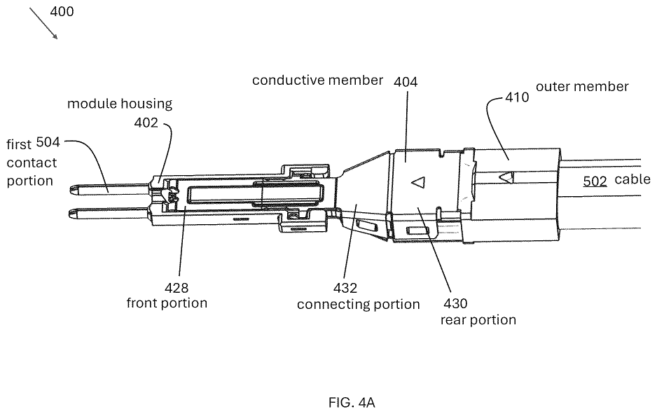

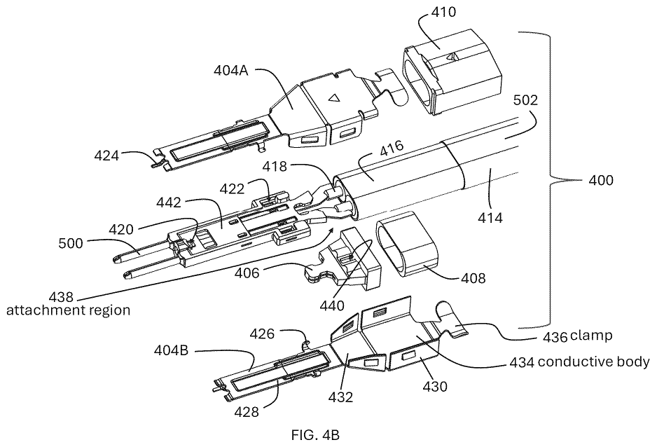

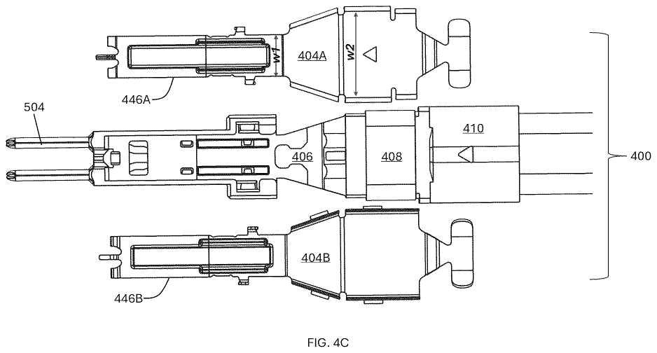

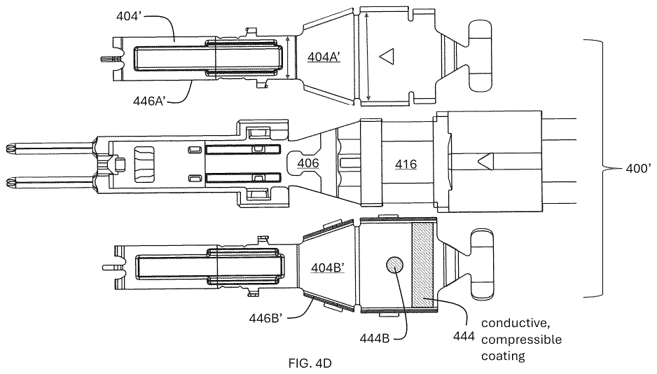

Modules 400 may be configured to provide shielding for the pairs of conductive elements 500 in individual modules 400 and to reduce interferences across modules 400. FIGS. 4A-4B show an assembled and a partially exploded perspective views of a module 400, respectively. In the illustrated example, module 400 may include a pair of conductive elements 500, a module housing 402 holding intermediate portion 508 of the pair of conductive elements 500, and a cable 502 attached to second contact portions 506 of the pair of conductive elements 500. First contact portions 504 of the pair of conductive elements 500 may extend out of the module housing 402 from a front end of module housing 402. Second contact portions 506 of the pair of conductive elements 500 may extend out of the module housing 402 from a rear end of module housing 402.

In some embodiments, a connector housing such as housing 200, module housing 402, inner member 406 may be dielectric members molded from a dielectric material such as plastic or nylon. Examples of suitable materials include, but are not limited to, liquid crystal polymer (LCP), polyphenylene sulfide (PPS), high temperature nylon or polyphenylene oxide (PPO) or polypropylene (PP). Other suitable materials may be employed, as aspects of the present disclosure are not limited in this regard. In some examples, the module housing 402 may be molded over intermediate portions of the pair of conductive elements 500. The module housing 402 may be integral or may have separately formed, either via successive molding operations or a single molding operation with a mold having multiple cavities.

In some embodiments, conductive elements such as conductive elements 500 and cable wires may be made of metal or any other material that is conductive and provides suitable mechanical properties for conductive elements in an electrical connector. Phosphor-bronze, beryllium copper and other copper alloys are non-limiting examples of materials that may be used. The conductive elements may be formed from such materials in any suitable way, including by stamping and/or forming.

A cable 502 may be attached to the pair of conductive elements 500 at the second contact portions 506. Cable 502 may include an insulative sheath 414, a conductive layer 416 extending inside the insulative sheath 414 and having an end extending beyond the insulative sheath 414, and a pair of wires 514 at least partially surrounded by the conductive layer 416 and having an end 418 extending beyond the end of the conductive layer 416 and attached to the second contact portion 506 of the pair of conductive elements 500 at an attachment region 438.

Module 400 may include an inner member 406 configured to enclose the attachment region 438. Inner member 406 may be shaped and sized to balance impedance at the attachment region 438 and/or mechanically reinforce the cable attachment to conductive elements 500. Inner member 406, for example, may be formed as a part of the module housing and may be overmolded after the cables have been attached to conductive elements 500. As illustrated, inner member 406 includes an air pocket 440 disposed between ends of the pair of wires 514 attached to respective second contact portions 506 of the pair of conductive elements 500. Inner member 406 may be shaped and sized to be secured to module housing 402. In the illustrated example, inner member 406 and module housing 402 include interlocking jigsaw puzzle features.

Module 400 may include a conductive member 404. The conductive member 404 may include a front portion 428, a rear portion 430, and a connecting portion 432 between the front portion 428 and the rear portion 430. Front portion 428 may be secured to module housing 402. Front portion 428 and module housing 402 may have complementary features for securing front portion 428 to module housing 402. In the illustrated example, module housing 402 may include a recess 442, a front opening 402, and side openings 422. Front portion 428 may be disposed in recess 442 of module housing 402. Front portion 428 may include a front beam 424 extending from a front thereof and configured to fit in front opening 420 of module housing 402, and side beams 426 extending from sides thereof and configured to fit in respective side openings 422 of module housing 402, so as to secure front portion 428 of conductive member 404 to module housing 402. In an assembled connector, front portion 428 may be inside an opening of organizer 212. If organizer 212 is or contains lossy material, this proximity of a portion of the shield to the organizer may damp resonances within the grounding and shielding structures, including conductive member 404.

Rear portion 430 may be secured to cable 502. As illustrated, rear portion 430 may include a clamp 436 configured to conformingly engage at least a portion of an outer surface of conductive layer 416 of the cable 502, so as to secure rear portion 430 of conductive member 404 to the cable and/or electrically connect conductive member 404 and conductive layer 416 of cable 502. Clamp 436, for example, may have arms that are deformed in a state where they are wrapped partially or fully around cable 502. Module 400 may include an outer member 410 configured to secure and/or reinforce the attachment of conductive member 404 to cable 502. As illustrated, outer member 410 may enclose both the clamp 436 of rear portion 430 of conductive member 404 and an end of the insulative sheath 414 of the cable 502. Outer member 410 may be molded over clamp 436 and a portion of cable 502. In some embodiments, outer insulative member 410 may comprise lossy material.

Connecting portion 432 may at least partially enclose attachment region 438. Connecting portion 432 may be shaped and sized to provide effective shielding and/or balance impedance at the attachment region 438. In the illustrated example, front portion 428 may have a first width w1 in the lateral direction perpendicular to the mating direction. Rear portion 430 may have a second width w2 in the lateral direction. Connecting portion 432 may have a width in the lateral direction transitioning substantially from the first width w1 to the second width w2.

In some embodiments, conductive member 404 may be formed of multiple portions that collectively provide grounding and shielding for signal conductive elements within the module. Member 404 has a first portion 404A and a second portion 404B disposed on opposite sides of the pair of conductive elements 500, in the example illustrated. FIG. 4C shows a plan view of the cable module of FIG. 4A, with first and second portions 404A and 404B of conductive member 404 moved in opposite directions. In some examples, first and second portions 404A and 404B may have substantially symmetrical features such that the same grounding structures are provided on both sides of conductive elements 500. In the example illustrated, first and second portions 404A, 404B are not fully symmetrical as they include complementary interlocking features. As illustrated, one of the portions may have protruding features; and the other of the portions may have openings configured to receive respective protruding features so as to be secured to each other. Front portions 428 of first and second portions 404A, 404B may be separated from each other by a distance depending on a thickness of module housing 402. Rear portions 430 of first and second portions 404A, 404B may be separated from each other by a distance dependent on a size of cable 502. In the illustrated example, for each of first and second portions 404A, 404B, front portion 428 and rear portion 430 may be offset from each other in a transverse direction perpendicular to both the mating direction and the lateral direction. Connecting portion 432 may join the front portion 428 and rear portion 430.

Conductive member 404 may have a conductive body 446. In some embodiments, conductive body 446 may be formed by, for example, stamping and folding a conductive sheet. A gap may exist between conductive body 446 and conductive layer 416 of cable 502. Conductive coating may be used to bridge the gap between conductive body 446 and conductive layer 416 of cable 502 and connect conductive body 446 and conductive layer 416 of cable 502. In the example illustrated, the conductive coating is applied to conductive member 404.

In some embodiments, as illustrated in FIGS. 4A-4C, a conductive material may be included to bridge a gap between conductive body 446 and conductive layer 416 of cable 502 so as to connect conductive body 446 and conductive layer 416 of cable 502. In the example illustrated, that conductive material is part of a compliant member 408 disposed in the gap.. Compliant member 408 may include an elastomer with conductive particles disposed therein and/or a conductive coating disposed thereon. In some embodiments, the conductive coating may have a thickness in a range of 10 μm to 40 μm, including any value or ranges of value within such range. In some embodiments, the conductive coating may be conductive ink. Optionally, the conductive ink may be a flexible carbon ink. In some examples, the conductive ink may bridge the gap without a base, such as an elastomer.

In some configurations, the gap between conductive body 446 and conductive layer 416 of cable 502 may be too small to accommodate a compliant member yet too large to effectively couple between conductive body 446 and conductive layer 416 of cable 502. This problem can arise, for example, when using cables with larger dimensions, such as 26 AWG. In some embodiments, as illustrated in FIG. 4D, a conductive, deformable coating 444 may be selectively disposed on an inner surface of conductive body 446. In some embodiments, the conductive, deformable coating 444, in an uncompressed state, may have a thickness equal to or greater than the gap between conductive body 446 and conductive layer 416 of cable 502. In some embodiments, the conductive, deformable coating 446 may have a thickness in a range of 50 μm to 500 μm, including any value or ranges of value within such range. In some embodiments, the conductive, deformable coating may be a conductive ink. Optionally, the conductive ink may be a silver filled polyester ink. A silver filled polyester ink may be formulated with finely dispersed silver particles embedded within a polyester resin system, ensuring adequate conductivity while maintaining flexibility and durability. Such silver-filled polyester ink may retain its conductivity even when subjected to mechanical stress, such as bending, stretching, or folding.

The inclusion of a conductive ink coating on conductive members shielding signal conductors may increase loss contributions to high frequency signal transmission in undesired directions. A conductive ink coating is typically less conductive than commonly plated metals, even at thicknesses described herein, which may be much thicker than commonly plated metals. The increased loss may provide signal integrity or electromagnetic radiation control benefits by, for example, damping resonance an/or adding loss to antenna-like patterns of electrical currents.

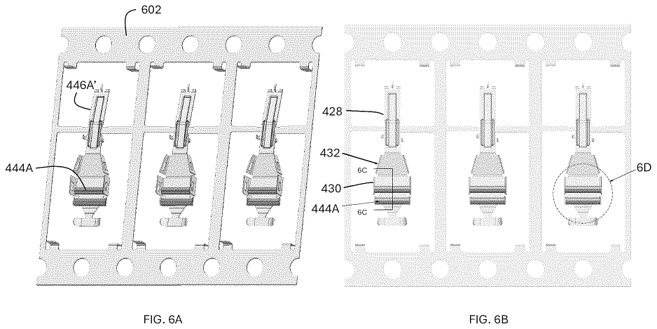

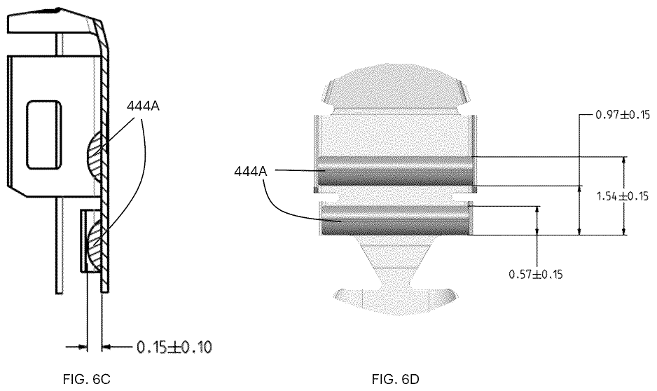

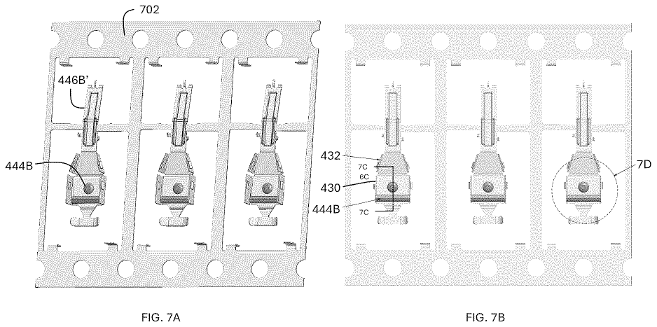

As shown in FIG. 4D, conductive member 404′ may include a first portion 404A′ and a second portion 404B′ disposed on opposite sides of the pair of conductive elements 500. First portion 404A′ may include body 446A, which may be configured similar to body 446A of first portion 404A of conductive member 404, and a first conductive, deformable coating (see, e.g., FIGS. 6A-6D) on at least a portion of body 446A′ and toward conductive layer 416 of cable 502. Second portion 404B′ may include body 446B, which may be configured similar as body 446B of second portion 404B of conductive member 404, and a second conductive deformable coating 444B on at least a portion of body 446B′ and toward conductive layer 416 of cable 502.

FIGS. 6A-6B show a perspective view and plan view of first portions 404A′ of conductive members 404′ of modules 400′ before being separated from a lead frame 602, respectively. FIG. 6C shows a partial cross-sectional view of first portions 404A′ along a line marked “6C-6C” in FIG. 6B. FIG. 6D shows an enlarged view of first portions 404A′ in a circle marked by “6D” in FIG. 6B. In the illustrated example, rear portion 430 of first portion 404A′ includes selectively disposed conductive, deformable coating 446A. Exemplary dimensions are shown in the FIGS. 6C-6D in millimeters (mm).

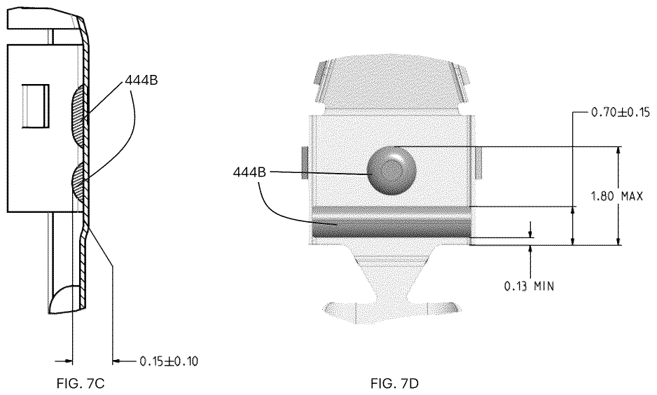

FIGS. 7A-7B show a perspective view and plan view of second portions 404B′ of conductive members 404′ of cable modules 400′ after stamping and forming and before being separated from a lead frame 702, respectively. FIG. 7C shows a partial cross-sectional view of second portions 404B′ along a line marked “7C-7C” in FIG. 7B. FIG. 7D shows an enlarged view of second portions 404B′ in a circle marked by “7D” in FIG. 7B. In the illustrated example, rear portion 430 of second portion 404B′ includes selectively disposed conductive, deformable coating 446B. Exemplary dimensions are shown in the FIGS. 7C-7D in millimeters (mm).

In some embodiments, a method for manufacturing a module 400′ for connector 100 may include forming conductive body 446A′ and/or 446B′ elongated in the mating direction of connector 100, and selectively applying a conductive, deformable coating 444A and/or 444B to an inner surface of rear portion 430 of conductive body 446A′ and/or 446B′. In some embodiments, selectively applying the conductive, deformable coating 444A and/or 444B may include disposing a conductive ink on the inner surface of rear portion 430 of conductive body 446A′ and/or 446B′, and curing the conductive ink disposed on the inner surface of rear portion 430 of conductive body 446A′ and/or 446B′.

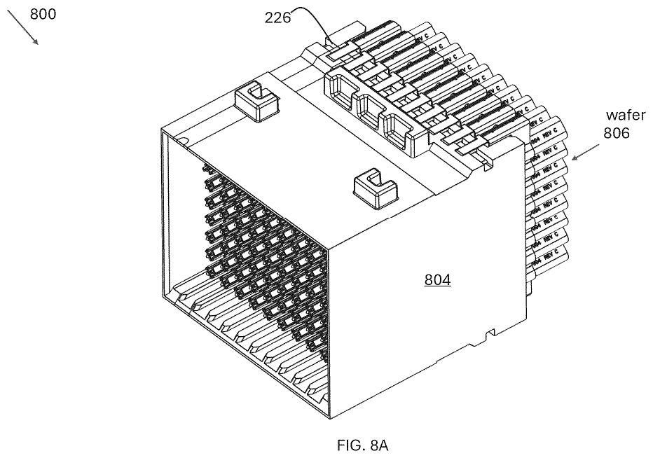

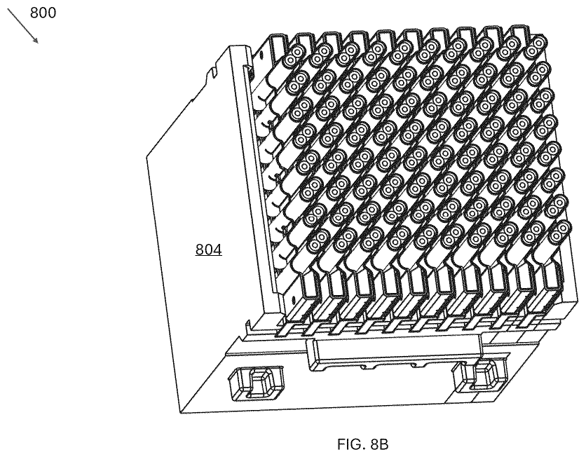

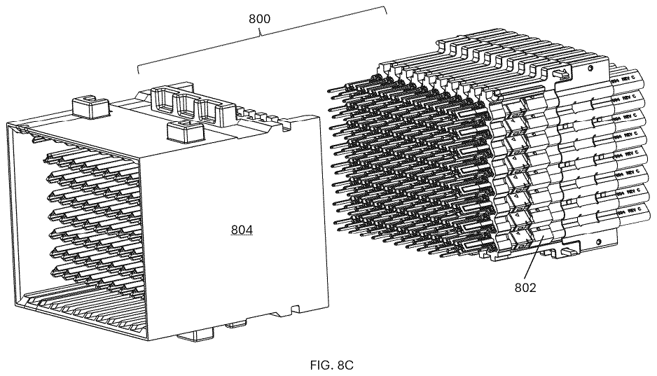

Although aspects of the present disclosure are described with respect to connector 100 having modules 400 arranged in two arrays of 4×9 and 4×10, techniques described herein can be adapted to provide high density, high speed connector with any suitable configurations. For example, FIGS. 8A-8C show an electrical connector 800 with modules 802 arranged in an 8×10 array. Connector 800 may include a housing 804 and wafers 806 held by the housing 804 and aligned in a row direction. Each wafer 806 may include a plurality of modules 802, for example, eight in the illustrated example, in a column direction. It should be appreciated that connector 800 may share features with connector 100, which may not be reiterated herein for simplicity and conciseness. For example, the modules, housing(s), organizer, and/or holders may be formed with structures and/or materials as described above in connection with other embodiments, such as connector 100.

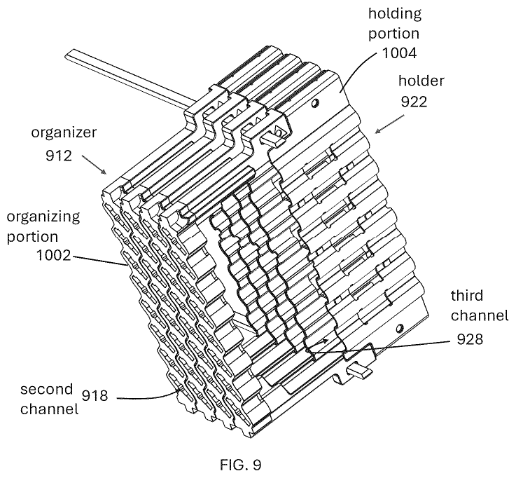

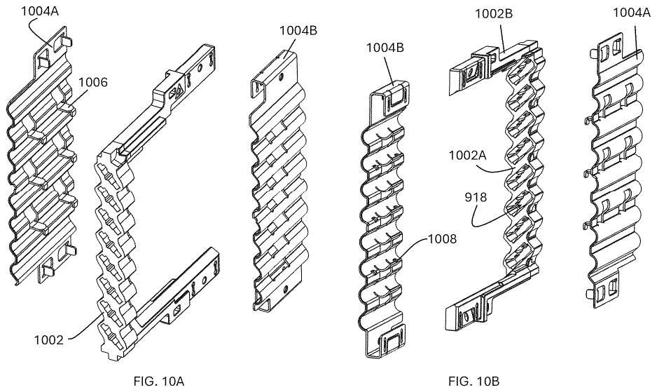

Connector 800 may include features configured to enable a taller connector with an angled mating interface, such as enhanced mechanical support and improved electrical shielding. FIG. 9 is a top, side perspective view of four wafers of connector 800, each with an organizer 912 and a holder 922, right side looking from the mating interface. Optionally, the organizer and holder may be joined, such as by molding the organizer in the same mold used to mold portions of the holder. The organizer and holder portions may be molded in a two shot molding operation, such that they may may be made of different materials (e.g. lossy and insulative thermoplastic material), or in one shot, such that they may be the same material (e.g. both lossy or both insulative). FIG. 10A is an exploded front perspective view of an organizing portion 1002 and a holding portion 1004 for a wafer 806 of connector 800. FIG. 10B is a rear perspective view of organizing portion 1002 and holding portion 1004.

As illustrated, organizing portion 1002 may include a front portion 1002A configured similar to organizing portion 302 of organizer 212 of connector 100 and having channels 918. In addition, organizing portion 1002 may include top and bottom portions 1002B extending from front portion 1002A. Top and bottom portions 1002B may include features of first side subportion 304A of holding portion 304 of connector 100, such as protrusion 234 and hole 236, for securing to housing 804.

Holding portion 1004 may include first side subportion 1004A and second side subportion 1004B. The first and second side subportions 1004A, 1004B may be stamped and formed from one or more conductive sheets. One or more of the components of holding portion 1004 may include features that hold the components together. Holding the components together may hold cables, such as via capturing cables between side subportions 1004A and 1004B. In the illustrated example, first side subportion 1004A includes beams 1006 configured to engage complementary openings of 1004B. Second subportion 1004B may include tabs 1008 curved to form angled channels 928, which may be substantially aligned with channels 918 of front portion 1002A of organizing portion 1002. Although holding portion 1004 is illustrated as having stamped first and second side subportions 1004A, 1004B, it should be appreciated that a holding portion may include one or more molded side subportions similar to first side subportion 304A of holding portion 304 of connector 100 in some embodiments.

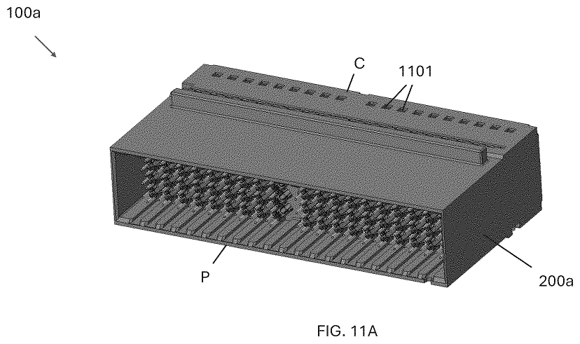

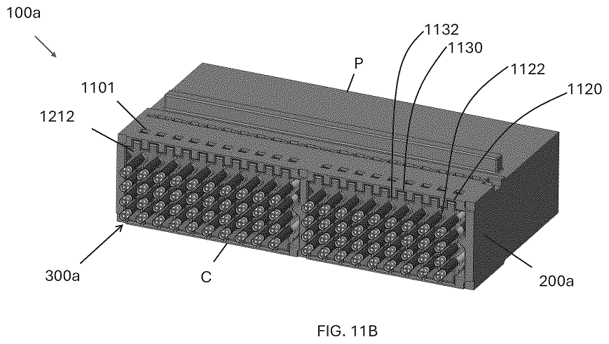

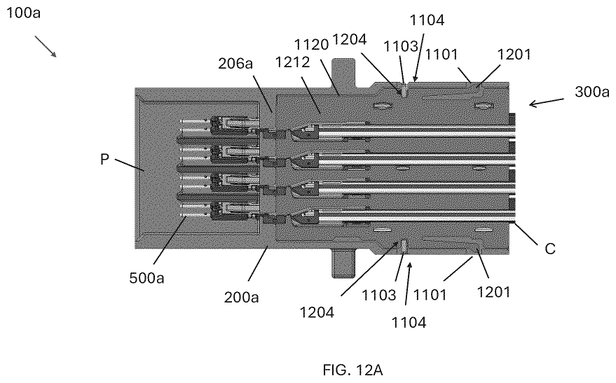

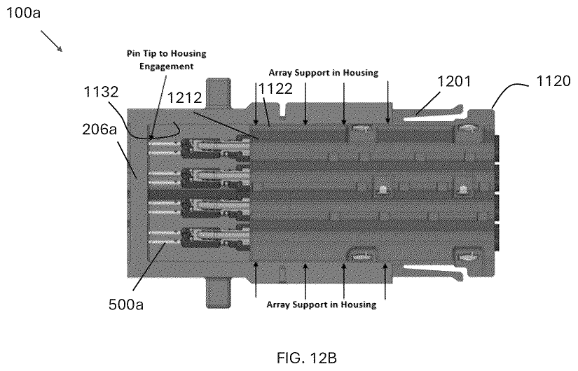

FIG. 11A shows another embodiment of an electrical connector 100a having a housing 200a. The illustrated embodiment includes fewer components, which may simplify manufacture, reduce the risk of damaging components such as mating contacts, and/or improve repeatability of the manufacturing operations such that the components of mass produced connectors are positioned in designed locations. These features may improve mechanical and electrical operation of the connector. The electrical connector 100a has a cable side C at which wafers are inserted and a protrusion side P that can be connected to a mating connector (not shown). FIG. 11A is a perspective view of the electrical connector 100a from the protrusion side P. Connector 100a may use the materials and construction techniques as described herein in connection with other connectors, but may differ with regard to connector 100 (e.g., of FIGS. 1A-1D) in a number of respects. As illustrated in FIG. 11A, the housing 200a of the connector 100a may extend farther in a direction of the cable side C of the connector in comparison with connector 100. Extending the housing 200a further on the cable side C may provide better structural support for the cable wafers and may enable alterative techniques to attach the cable wafers to the housing. Alternative wafer attachment techniques, for example, may facilitate assembly and/or rework of a connector.

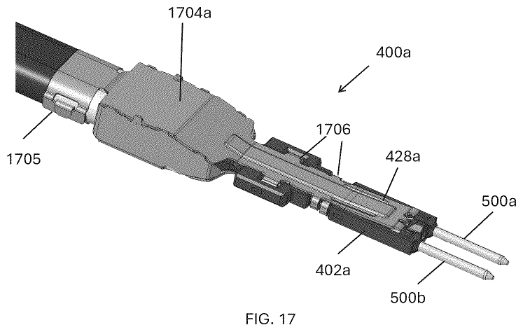

Connector 100a is also illustrated with features that reduce the risk of damage to the mating contacts during assembly. FIG. 11B is a perspective view of the electrical connector 100a from the cable side C. As discussed further below, the cable wafers 300a may be inserted into the housing in an insertion direction from the cable side C to the protrusion side P. The additional support for the cable wafers 300a restricts pivoting of the cable wafers 300a about an axis perpendicular to the insertion direction, which reduces the potential for damage to the conductive elements 500a (FIG. 17) and improves alignment of the conductive elements 500a.

As shown in FIG. 11B, the cable wafers 300a may include a frame 1212 that holds cables and provides mechanical support for the cable wafer 300a in housing 200a. In some embodiments, the frame 1212 extends substantially an entire length of the cavity, and in some embodiments extends to the rear surface of the housing 200a when the cable wafers 300a are fully inserted in the housing 200a, as illustrated in FIG. 11B. The rear surface of the frame 1212 may be flush with the rear surface of the housing 200a at the cable side C, as shown in FIG. 11B. Alternatively or additionally, frame 1212 may include features that releasably engage housing 200a. Such features may hold the wafers in the housing but enable the wafers to be released from the housing, which may enable easy removal of a wafer from the housing. An example of such an engagement feature is a latch.

FIGS. 11A and 11B also show that housing 200a may have latch retention regions 1101 which are illustrated as square holes in the top of the housing 200a toward the cable side C. Although not visible in FIGS. 11A and 11B, similar latch retention regions 1101 may also be located on the bottom of housing 200a. The cable wafers 300a may include corresponding latches that fit into the latch retention regions 1101 when the wafers are inserted, and which retain the cable wafers 300a in the housing 200a. Although shown as square holes, the latch retention regions 1101 may have a different shape in other embodiments.

FIG. 11B illustrates how edges (in this example both top and bottom edges) of wafers 300a may be shaped to engage with a surface of the housing (in this example, surfaces of the top and bottom walls of the housing 200a) to resist pivoting of the wafers. In this example, an edge of the wafer includes a protruding rail 1120, which extends parallel to the insertion direction. The rail 1120 forms a ridge on the upper surface of the wafer 300a that may fit within a groove 1130 of the housing 200a. As can be seen in FIG. 11B, multiple parallel grooves 1130 may be formed in a top wall of the housing 200a such that multiple wafers 300a may be inserted in parallel. Similar structures may optionally or additionally be formed in the bottom wall and the bottom edge of the wafers 300a.

In the example of FIG. 11B, rail 1120 extends across only a portion of the lateral direction of the wafer 300a. Consequently, a portion of the upper surface 1122 of the wafer is adjacent to the rail. Similarly, a portion of a surface 1132 of the upper wall of the housing 200a is adjacent to the groove 1130. When a wafer 300 is inserted into the housing, surface portions 1122 and 1132 will be adjacent to each other. Those surfaces may engage one another to resist pivoting of the wafer around an axis perpendicular to the direction of insertion. With restricted pivoting, the risk of damage to the conductors 500a extending from the forward portion of the wafers is reduced. Engagement of the rails 1120 with grooves 1130 resists pivoting of the wafers in an orthogonal direction and may similarly contribute to a reduced risk of damage to the extending conductors.

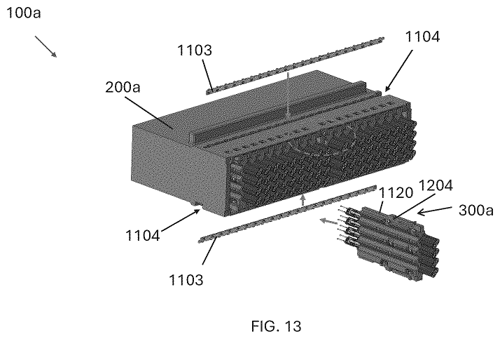

FIG. 12A shows a side view through a cross-section of the interior of the connector 100a, according to some embodiments. The cross section in this example is through a rail 1120 and corresponding groove 1130. In this example, connector 100a includes a one-piece wafer support structure, which acts as both an organizer and a support structure for a plurality of terminated cables. Frame 1212 is an example of a wafer support structure. In particular, FIG. 12A shows a side sectional view at an upper top rail 1120 of the frame 1212 (see also FIG. 13) aligned with the latch 1201 when the frame 1212 is fully inserted into the housing 200a from the cable side C. The bottom of the frame 1213 and housing may have the same or similar characteristics. The front (left side) of the frame 1212 of cable wafers 300a may extend to the inner wall 206a of the housing 200a when the cable wafer 300a is fully inserted from the cable side C. To reach this position, the exposed distal ends of contacts 500a pass through apertures in wall 206a.

In contrast to connector 100, in this embodiment the connector 100a, frame 1212 acts as both a holder and an organizer. The rear of frame 1212 of the cable wafers 300a may be flush with the rear surface of the housing 200a at the cable side C (as seen at the right side of FIG. 12A). When the cable wafers are fully inserted, the latches 1201 protrude into the latch retention regions 1101, thereby retaining the cable wafers 300a in the housing 200a. The latches 1201 may allow ease of assembly and/or disassembly for repair, which may be a benefit during cable harness building. For example, a cable harness used as a portion of a cable backplane in an electronic system may include multiple connectors, such as connector 100a, at multiple ends of bundles of cables, making numerous connections. An assembly error, such as inserting a cable in the wrong location in a wafer or inserting the wafer in the wrong location in a connector, may be detected as a result of testing or inspection. By enabling a wafer in the wrong location or with the wrong cable configuration to be easily removed from the connector housing, the identified assembly error can be quickly resolved.

In some examples, additional features may alternatively or additionally hold wafers in the housing. FIG. 12A also shows that one or more tie-bars 1103 may be inserted into slots in the housing 200a and the frame 1212 to retain the wafers 300 in the housing. As shown in FIG. 12A, after the latches 1201 are engaged in the latch retention regions 1101 for all of the cable wafers 300a, tie-bars 1103 may be inserted into tie-bar retention slots 1104 at the top and bottom of the housing 200a as well as corresponding tie-bar retention slots 1204 of frames 1212. Tie-bars 1103 ensure good final array retention. In some examples, features of housing 200a that receive the tie bars 1103 may be configured to enable simple removal of the tie bar, as discussed further below. Once tie-bar 1103 is removed, a cable wafer 300a may be disengaged from the housing by pressing the latches inward through the latch retention regions 1101, and applying a force to slide the cable wafer 300a out of the housing 200a.

As shown in FIG. 12A, the frame 1212 may be a unitary structure, in contrast to the separate holder 222 and organizer 212 of connector 100. A unitary structure may reduce the number of parts in the connector and simplify manufacturing. Additionally or alternatively, a unitary structure for frame 1212 may provide more surface area on the wafer support structure at the distal end of the wafer. This additional surface area may abut the connector housing to restrict pivoting of the cable wafers 300a during installation, which reduces the potential for damage to the conductive elements 500a and improves alignment of the conductive elements 500a.

FIG. 12B is another side sectional view of the electrical connector of FIG. 11A, sectioned through a wafer of the connector of FIG. 11A with the frame partially inserted, according to some embodiments. In particular, FIG. 12B shows a side sectional view when the frame 1212 is partially inserted into the housing 200a from the cable side C. The first chamber into which to forward exposed ends of contacts 500a extend when the wafer is fully inserted is not shown for simplicity. The section is taken through a wafer 300a in front of a rail 1120.

As can be seen in the example of FIG. 12B, a surface of the frame 1212 abuts a surface of the housing 200a substantially along an entire length of the frame 1212 as the frame 1212 is inserted into the housing 200a. In this example, an upper surface 1122 of the wafer adjacent rail 1120 abuts surface 1132 of the housing. Surface 1132 is adjacent groove 1130, which is not visible in this view. The surfaces may abut in the sense that they are sufficiently close together that, if wafer 300a were to pivot about an axis perpendicular to the insertion direction and perpendicular to the illustrated plane, surface 1122 will contact surface 1132 at one or more locations, interfering with that pivoting motion.

In some embodiments, a surface of the frame abuts a surface the housing for at least 70% of the length of the frame, at least 80% of the length of the frame and/or at least 90% of the length of the frame at a point during or after the insertion of the frame into the housing, an example of which is illustrated in FIGS. 12A and 12B. When the frame is fully inserted into the housing, the frame may extend at least 70%, 80% and/or 90% of the length of the cavity in the insertion direction-at least 70%, 80% and/or 90% of the distance between the wall 206a and the rear (right side in FIG. 12A) of the housing. Though abutting surfaces adjacent to a rail on the wafer and adjacent a groove in the housing are used to illustrate the principle, abutting surfaces in other locations may restrain pivoting. A surface on the rail, for example, may abut a surface defining a floor of the groove in the housing.

FIG. 13 shows a perspective view of connector 100a illustrating insertion of the tie-bars 1103 on the top and bottom housing 200a in tie-bar retention slots 1104 following the insertion of the cable wafers 300a into the housing. As can also be seen in FIG. 13, each wafer 300a fits into channels in the top and bottom walls of the housing 200a. Tie bars 1103 may be inserted into the housing after all wafers have been installed. The tie bars may extend into slots in the wafer. In this example, tie bars 1103 extend into slots 1204 in the rails of the wafers, providing an additional mechanism to hold the wafers in the housing.

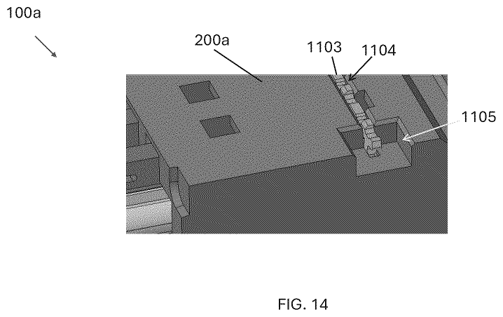

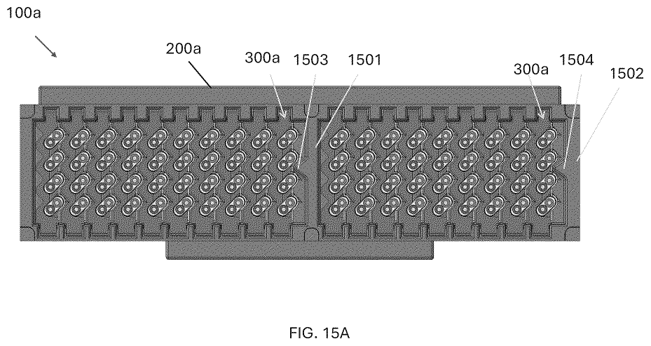

FIG. 14 shows a detail perspective view of a portion of the top and a side of the housing 200a showing a tie-bar repair slot 1105. The tie-bar repair slot may be a recessed region of the housing 200a allowing access to the tie-bar 1103 and allowing ease of removal of the tie-bar 1103. In this example, tie-bar repair slot 1105 is at a corner of two surfaces, including the surface through which the tie bar is inserted into housing 200a. Such a configuration exposes an end of tie-bar 1103 through an alternative surface such that it may be grasped or pushed with a tool for easy removal of tie-bar 1103. In other examples, the repair slot may be open only at one surface, and may be configured to allow access to the tie-bar for removal in other ways. The slot, for example, may be large enough to enable a tool to be inserted and grasp the tie bar for removal. Removal of the tie-bar 1103 allows for removal and repair of cable wafers 300a. A tie-bar repair slot may enable the tie bar to be removed such that wafers may be removed for repair. In this example, as there are both tie bars and latches holding the wafers in the housing, once the tie bars are removed, the latches 1201 of a wafer may be depressed through the opening forming the latch retention regions 1101 to release the wafer from the housing.

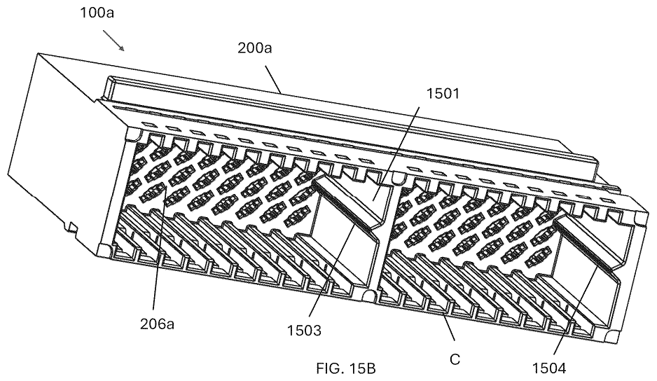

FIG. 15A shows an end-view from the cable side C illustrating features of the housing 200a that may provide additional mechanical support. In particular, the housing 200a may include an inner wall 1501 to provide additional mechanical support for housing 200a. The inner wall 1501 may extend between the top and bottom of the housing 200a. The inner wall 1501 may be positioned approximately at a center of the housing 200a between respective sets of cable wafers 300a. The inner wall 1501 and/or an outer wall 1502 may include support ribs 1503, 1504 extending into the page of FIG. 15A along the insertion direction of the cable wafers 300a. The support ribs 1503, 1504 may be shaped to fit within a side recess of a cable wafer 300a and may provide mechanical support for the cable wafers 300a. The support ribs 1503, 1504 reduce pivoting of the wavers about an horizontal direction transverse to the cable insertion direction, thereby maintaining alignment of the conductors 500a with the aperture in the wall 206a and avoiding damage to the conductors 500a. In this example, the support ribs 1503 and 1504 are positioned approximately at the center of the housing 200a along the vertical direction of FIG. 15A between the top and bottom of the housing 200a.

FIG. 15B shows a perspective view of the housing 200a, illustrating the inner wall 1501 and the support ribs 1503, 1504, which may extend from inner wall 206a to the rear of the connector 100a at the cable side C.

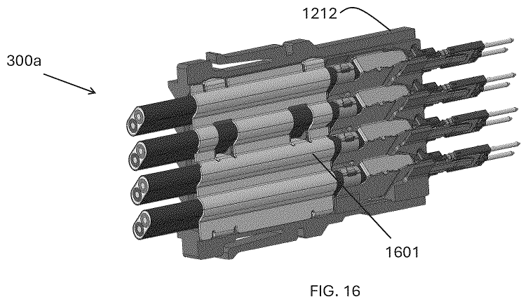

FIG. 16 shows a perspective view of a cable wafer 300a, illustrating frame 1212 may be a single piece. Terminated cables may be secured in the frame 1212 by a metal cover 1601. One or more attachment features may be included on the frame and/or cover to hold cover 1601 to frame 1212 so as to capture terminated cables between them.

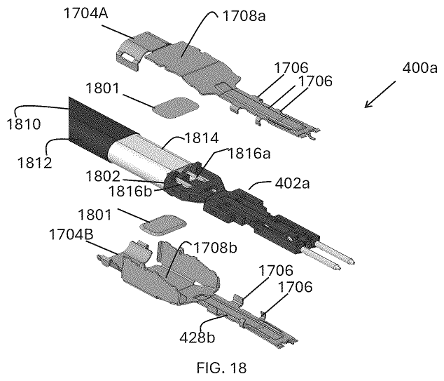

FIG. 17 is a perspective view of another example of a cable module 400a, according to some embodiments. Cable module 400a is an example of a cable module that may be inserted into a cable wafer 300a. In the example of FIG. 16, four such cable modules are shown held in frame 1212. Cable module 400a may have a number of the same or similar components as cable module 400. Rather than repeating a description of the same or similar components, differences between cable module 400 and cable module 400a are described. As shown in FIG. 17, the cable module 400a has a conductive shield 1704 in place of conductive members 404A and 404B of cable module 400. The conductive shield 1704 may be formed of one or more conductive members, such as conductive members 1704A, 1704B (FIG. 18). In the illustrated example, the conductive members are welded together. Though other techniques may be used to join conductive members into a shield that fully or partially encloses signal conductors terminating a cable, welding the conductive members of the conductive shield may reduce assembly variation and improve signal integrity. The latches used to hold the conductive members together may be eliminated as shown in FIG. 17—the side of the conductive shield 1704 may be free of latches. Though, in some examples, the latches may provide adequate retention of conductive members or may be used in combination with welding.

Cable crimp 1705 may be an extension of the conductive shield 1704, and may provide improved strain relief. In the example illustrated, cable crimp 1705 may be formed by the attaching portions of conductive members 1704A, 1704B positioned on opposite sides of a cable to each other. The fastening mechanism at the cable crimp 1705 may be different than the fastening mechanisms used at different portions of conductive members 1704A, 1704B. For example, latching features at the cable crimp portions may be stamped from the conductive members 1704A, 1704B whereas welding may be used elsewhere. In some examples, the cable crimp 1705 may press against an insulative jacket on the exterior of the cable. Such a configuration may provide mechanical attachment of the cable module to the cable. Alternatively or additionally, the cable crimp 1705 may press against an exposed segment of a cable shield to provide electrical and mechanical connection of the module to the cable.

In the illustrated example, the cable may be a twinax cable with two signal conductors. To terminate the signal conductors of the cable, cable module 400a may have two conductive members 500a and 500b. The conductive members 500a and 500b may have at one end, mating contacts. In this example, the mating contacts are configured as pins, which can be seen extending from an insulative housing. The pins may have an increased thickness relative to mating contacts of a conventional design, which may help prevent damage to the pins. In some embodiments, the mating contacts of conductive members 500a, 500b may have a diameter of approximately 0.12 mm.

The front portion 428a may have additional tabs 1706 for securing the front portion 428a to module housing 402a, which may be formed of the same or similar materials as described above for module housing 402. Providing additional tabs 1706 for securing the front portion 428a to module housing 402a may improve signal integrity.

FIG. 18 shows an exploded view of cable module 400a. In this view, conductive members 1704A, 1704B are both visible. As can be seen, when attached to each other, conductive members 1704A, 1704B substantially surround the conductive elements 500a, 500b extending through the cable module.

Also visible in FIG. 18 is a front portion 428b of conductive member 1704B. Front portion 428b similarly includes tabs 1706 for securing conductive member 1704B to the cable module housing 402a, which similarly improves performance.

Module 400a is shown attached to a cable 1810 (an end of which is shown with the rest of the cable cut away) to form a cable assembly. Cable 1810 may have a conventional twinax cable construction, with an outer insulative layer, depicted as jacket 1812. For termination of cable 1810 to a cable module 400a, jacket 1812 may be stripped from cable 1810. A cable shield 1814 may be exposed where jacket 1812 is removed. Cable shield 1814 may be a layer of metal, such as metal foil, bounding an insulator withing the cable. Signal conductors 1816a and 1816b may be embedded in the insulator. At the distal end of the cable, the insulator as well as cable shield 1814 may be removed, exposing signal conductors 1816a and 1816b. The ends of the signal conductors 1816a and 1816b may be terminated to tails of conductive elements 500a and 500b in module 400a.

Electrical connection between conductive members 1704A and 1704B and cable shield 1814 may be made by cable clamp 1705. Alternatively or additionally, electrical connections may be made at other locations of conductive members 1704A and 1704B. In the example illustrated, electrical connection may be made at body portions 1708a and 1708b, which also overly exposed portions of shield 1814. Flat gaskets may be positioned between cable shield 1814 and body portions 1708a and 1708b to enhance the reliability of the contact, which may in turn improve electrical performance. Flat gaskets 1801 may be flat conductors which may serve the same function as a conductive layer 416 made of conductive ink. Using flat gaskets 1801 without separately applying conductive ink may eliminate the time needed for curing conductive ink. The gaskets may be made of an elastomer, such as silicone or silicone rubber which may be filled or coated with a conductive material. The gasket may be filled, for example, with silver spheres. In some examples, flat gaskets 1801 may be coated with conductive ink. The gasket may be coated and cured in a separate process such that curing does not occur during the assembly of the cable module.

The module housing 402a may have a positive cable stop 1802, which may provide position repeatability and an improvement in signal integrity. As shown, the insulator of cable 1812 abuts the module housing 402, which improves the alignment of signal conductors 1816a and 1816b with respect to tails of the conductive elements to which the cable signal conductors are attached in a cable assembly. In the illustrated example, the tails are shaped as weld tabs 1910a and 1910b and signal conductors are attached via welding. Improving alignment facilitates welding of the signal conductors to the edges of the weld tabs and may enable faster and/or more reliable manufacture of the cable assembly.

The module housing 402a around the weld tabs may also improve strength of the module 400a, which may resist damage.

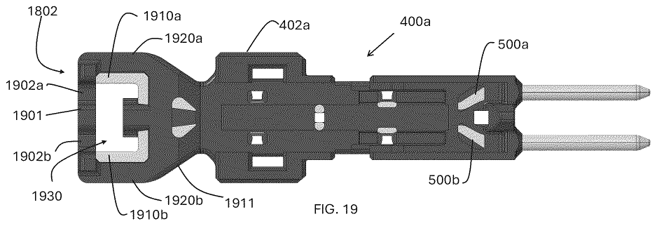

FIG. 19 shows a top view of cable module 400a, with shields for the cable module hidden. Cable module 400a in this example is formed by overmolding housing 402a on conductive elements 500a and 500b. In this example, housing 402a may be formed in a single molding operation, resulting in an integral and substantially uniform housing. Portions of conductive elements 500a and 500b may be exposed at the mating end and the cable mounting end. In the view of FIG. 19, pin-shaped mating contacts are exposed at one end and weld tabs 1910a and 1910b are exposed at the opposite end. Portions of intermediate portions connecting the weld tabs to the mating contacts may also be exposed, to shape electrical performance and or facilitate holding conductive elements 500a and 500b in an insert molding operation.

Housing 402a is shaped to frame a region in which weld tabs 1910a and 1910b are exposed. In the example of FIG. 19, one end of a region 1930 is bounded by an intermediate portion 1911 of housing 402a holding intermediate portions of the conductive elements 500a and 500b. Housing 402a has side portions 1920a and 1920b extending from the intermediate portion and bounding respective sides of region 1930. The side portions 1920a and 1920b are joined by end wall 1901 of housing 402a.

In this example, at least edges of weld tabs 1910a and 1910b are exposed in region 1930. Such a configuration supports attachment of cable conductors to tails of the conductive elements 500a and 500b via welding to the edges.

The housing end wall 1901 acts as a forward stop for the cables. In the example illustrated, housing end wall 1901 includes grooves 1902a and 1902b that cradle cable signal conductors 1816a and 1816b, respectively. FIG. 19 shows broadsides of the weld tabs, with edges of the weld tab extending perpendicularly into the page. Edges of the grooves 1902a and 1902b are aligned with edges of weld tabs. Such an arrangement may position signal conductors cradled in the grooves 1902a and 1902b for attachment to the edges of the weld tabs.

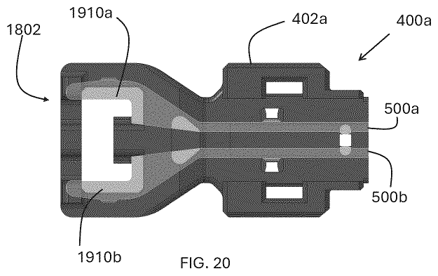

FIG. 20 is a top view of a rear portion of the cable module 400a. The conductive elements 500a and 500b are shown in phantom within housing 402a. The location of the edges of the weld tabs relative to the cable stop can be seen.

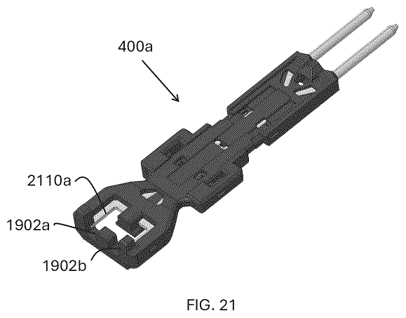

FIG. 21 shows a perspective view of the cable module 400a. Edge 2110a of weld tab 1910a is visible in this view. Weld tab 1910b similarly has an edge, which is not visible in the view of FIG. 21. Grooves 1902a and 1902b, which are positioned to align signal conductors of a cable with the edges of the weld tabs are also visible in this view. As can be seen, edge 2110a is aligned with the edge of groove 1902a. In this example, edge 2110a is exposed in a wall of groove 1902a.

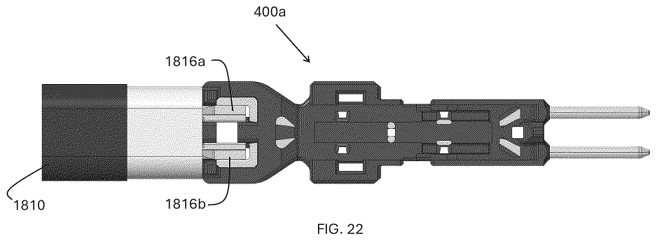

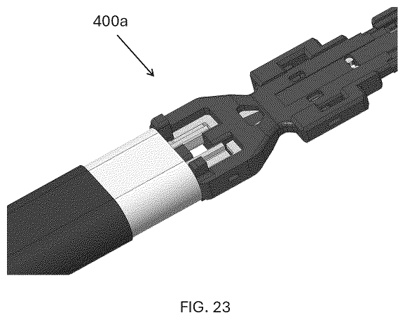

FIGS. 22 and 23 show a top view and perspective view, respectively, of the cable module 400a with cable 1810 attached. As can be seen, signal conductors 1816a and 1816b are cradled in grooves 1902a and 1902b, such that they align with the edges of the weld tabs. Cable 1810 is pushed forward to abut end wall 1901 of the housing 402a. Such alignment facilitates attachment of the signal conductors to the tabs, such as via welding.

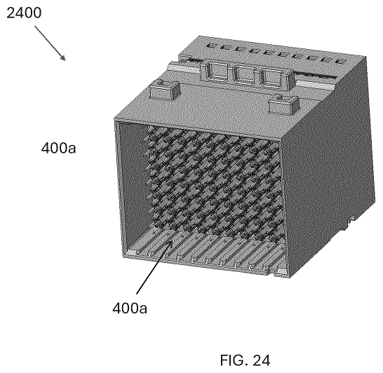

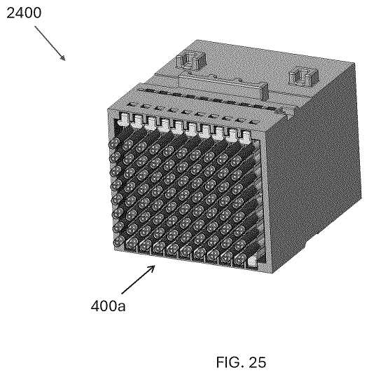

Although aspects of the present disclosure are described with respect to connector 100a having modules 400a arranged in a 4×19 array (including two arrays of 4×10 and 4×9), the techniques described herein can be adapted to provide ahigh density, high speed connector with any suitable array size. For example, FIGS. 24 and 25 show an electrical connector 2400 with modules 400b arranged in an 8×10 array. Connector 800 may include a housing and wafers held by the housing and aligned in a row direction. Each wafer may include a plurality of modules 400b, for example, eight in the illustrated example, in a column direction. It should be appreciated that connector 2400 may share features with connector 100a, which may not be reiterated herein for simplicity and conciseness.

Having thus described several aspects of at least one embodiment of this invention, it is to be appreciated that various alterations, modifications, and improvements will readily occur to those skilled in the art.

As one example, FIG. 1C illustrates a mating interface of a connector in which mating contacts, shaped as pins, extend into a chamber of a connector housing. The chamber may be formed by walls bounding the mating interface. Such walls are optional. Walls bounding the mating interface may, for example, be part of a mating connector or may be omitted.

Such alterations, modifications, and improvements are intended to be within the spirit and scope of the invention. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value. For example, a phrase “between 10 and 20” is intended to mean “between exactly 10 and exactly 20” in some embodiments, as well as “between 10±d1 and 20±d2” in some embodiments. The amount of variation d1, d2 for a value may be less than 5% of the value in some embodiments, less than 10% of the value in some embodiments, and yet less than 20% of the value in some embodiments. When only exact values are intended, the term “exactly” is used, e.g., “between exactly 2 and exactly 200.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1.-14. (canceled)

15. A wafer for an electrical connector, comprising:
an organizing portion elongated in a column direction and comprising a plurality of channels, each of the plurality of channels having a cross-section elongated in a first direction oblique to the column direction; and
a plurality of modules aligned by the organizing portion, each of the plurality of modules comprising:
a module housing partially disposed in a respective channel of the plurality of channels of the organizing portion and extending beyond the organizing portion in a mating direction, and
at least one conductive element each comprising a first contact portion extending out of the module housing in the mating direction and a second contact portion extending out of the organizing portion in a direction different from the mating direction.

16. The electrical connector of claim 15, wherein:
the first direction extends at an angle between 30° and 70° relative to the column direction.

17. The wafer of claim 15, wherein:
the organizing portion comprises first and second serpentine sides, with concave segments of the first serpentine side facing convex segments of the second serpentine side.

18. The wafer of claim 17, wherein:
the organizing portion is lossy.

19. The wafer of claim 15, wherein:
each of the plurality of modules comprises a cable attached to the second contact portion of the at least one conductive element.

20. The wafer of claim 19, wherein:
the cables of at least two of the plurality of modules extend to different lengths so as to connect to a circuit board at different locations.

21. The wafer of claim 19, wherein:
for each of the plurality of modules, the at least one conductive element is a pair of conductive elements aligned in the first direction; and
each of the plurality of modules comprises a pair of wires attached to the second contact portions of respective conductive elements of the pair of conductive elements.

22. The wafer of claim 21, wherein:
each wire contacts a respective second contact portion at a first contact location at a tip of the wire and at a second contact location at a side of the wire.

23. The wafer of claim 21, wherein:
the first contact portions of the pair of conductive elements are separated from each other by a first distance;
the second contact portions of the pair of conductive elements are separated from each other by a second distance greater than the first distance; and
the intermediate portions of the pair of conductive elements are separated from each other by a third distance less than the first distance.

24. The wafer of claim 23, wherein:
each of the pair of conductive elements comprises a first transitioning portion joining the first contact portion and the intermediate portion, and a second transitioning portion joining the intermediate portion and the second contact portion; and
the second transitioning portion is disposed in a respective channel of the plurality of channels of the organizing portion.

25. The wafer of claim 19, comprising:
a holding portion aligning the cables in the column direction and comprising third and fourth serpentine sides, with concave segments of the third serpentine side facing convex segments of the fourth serpentine side.

26. The wafer of claim 19, wherein:
the holding portion comprises a first side subportion having the third serpentine side, and a second side subportion having the fourth serpentine side;
the first side subportion comprises a fifth side opposite the third serpentine side; and
the second side subportion comprises a sixth side opposite the fourth serpentine side and engaging the fifth side of the first side subportion at a plurality of locations.

27. The wafer of claim 26, wherein:
the first side subportion and the second side subportion comprise different materials.

28. The wafer of claim 26, wherein:
the first side subportion is molded; and
the second side subportion is stamped.

29. The wafer of claim 28, wherein:
the first side subportion is lossy.

30. A module for an electrical connector, comprising:
at least one conductive element comprising a first contact portion, a second contact portion, and an intermediate portion between the first contact portion and the second contact portion;
a cable comprising an insulative sheath, a conductive layer extending inside the insulative sheath and having an end extending beyond the insulative sheath, and at least one wire at least partially surrounded by the conductive layer having an end extending beyond the end of the conductive layer and attached to the second contact portion of the at least one conductive element at an attachment region; and
a conductive member comprising:
a conductive body at least partially enclosing the attachment region, and
a conductive, deformable coating on at least a portion of the conductive body and toward the conductive layer of the cable.

31. The module of claim 30, wherein:
the conductive, deformable coating of the conductive member electrically connects the conductive layer of the cable to the conductive body of the conductive member.

32. The module of claim 30, wherein:
the conductive, deformable coating, in an uncompressed state, has a thickness equal to or greater than a gap between the conductive body and the conductive layer of the cable.

33. The module of claim 32, wherein:
the conductive, deformable coating has a thickness in a range of 50 μm to 500 μm.

34. The module of claim 30, wherein:
the conductive, deformable coating is a conductive ink.

35. The module of claim 34, wherein:
the conductive ink comprises silver.

36. The module of claim 30, wherein:
the conductive body is a first conductive body;
the conductive, deformable coating is a first conductive, deformable coating on at least a portion of the first conductive body;
the conductive member comprises a first portion and a second portion disposed on opposite sides of the at least one conductive element;
the first portion of the conductive member comprises the first conductive body and the first conductive, deformable coating; and
the second portion of the conductive member comprises a second conductive body and a second conductive, deformable coating on at least a portion of the second conductive body and toward the conductive layer of the cable.

37. The module of claim 30, wherein:
the first conductive, deformable coating and the second conductive, deformable coating are shaped and sized to electrically connect the conductive layer of the cable to the conductive body of the conductive member.

38. The module of claim 30, comprising:
a module housing holding the intermediate portion of the at least on conductive element, the module housing comprising a recess and one or more openings, wherein:
the conductive body of the conductive member comprises a front portion disposed in the recess of the module housing; and
the conductive member comprises one or more beams extending from the front portion and fitted in respective openings of the one or more openings of the module housing.

39. The module of claim 38, wherein:
the conductive body of the conductive member comprises a rear portion, and a connecting portion between the front portion and the rear portion;
the connecting portion of the conductive body at least partially encloses the attachment region; and
the conductive, deformable coating is selectively disposed on the rear portion of the conductive body.

40. The module of claim 39, comprising:
an inner member separating the attachment region from the conductive member, wherein:
the at least one conductive element is a pair of conductive elements;
the first contact portions of the pair of conductive elements are separated from each other by a first distance, and the second contact portions of the pair of conductive elements are separated from each other by a second distance greater than the first distance; and
the at least one wire is a pair of wires having end attached to respective second contact portions of the pair of conductive elements.

41. The module of claim 40, wherein:
the inner member comprises an air pocket disposed between ends of the pair of wires attached to the respective second contact portions of the pair of conductive elements.

42. The module of claim 40, wherein:
the inner member is interlocked to the module housing.

43. The module of claim 40, wherein, for the conductive body of the conductive member:
the front portion has a first width in a lateral direction perpendicular to the mating direction;
the rear portion has a second width in the lateral direction; and
the connecting portion has a width in the lateral direction transitioning substantially from the first width to the second width.

44. The module of claim 43, wherein:
the front portion and the rear portion are offset from each other in a transverse direction perpendicular to both the mating direction and the lateral direction.

45. The module of claim 39, wherein:
the rear portion of the conductive body of the conductive member comprises a clamp conformingly engaging at least a portion of an outer surface of the conductive layer of the cable; and
the module comprises an outer member enclosing both the clamp of the rear portion of the conductive body of the conductive member and an end of the insulative sheath of the cable.

46.-59. (canceled)

60. An electrical connector comprising:
a housing comprising a first chamber, a second chamber and a dividing wall between the first chamber and the second chamber, wherein:
the dividing wall comprises a plurality of apertures therethrough;
the housing comprises a top wall with a top surface bounding the second chamber and a bottom wall with a bottom surface bounding the second chamber; and
the housing comprises opposing grooves in the top surface and the bottom surface;
a plurality of wafers, each of the plurality of wafers comprising:
a top edge profiled with a first rail extending into a respective groove in the top wall of the housing and a first surface, adjacent the first rail and adjacent the top surface of the top wall and configured to resist pivoting of a wafer via engagement with the top surface; and
a bottom edge profiled with a second rail extending into a respective groove in the bottom wall of the housing and a second surface, adjacent the second rail and adjacent the bottom surface and configured to resist pivoting of the wafer via engagement with the bottom surface.

61. The electrical connector of claim 60, wherein,
the housing has an opening into the second chamber bounded by a rearward edge of the top wall and a rearward edge of the bottom wall; and
for each of the plurality of wafers,
the first surface is adjacent the top surface of the housing over at least 50% of a distance between the dividing wall and the rearward edge of the top wall; and
the second surface is adjacent the bottom surface of the housing over at least 50% of the distance between the dividing wall and the rearward edge of the bottom wall.

62. The electrical connector of claim 60, wherein the housing includes at least one rib extending along an insertion direction of the plurality of wafers, the at least one rib being configured to interlock with a side surface of at least one wafer of the plurality of wafers, thereby resisting pivoting of the at least one wafer.

63. The electrical connector of claim 60, wherein the plurality of wafers are configured to interlock with one another, thereby resisting pivoting of the plurality of wafers.

64.-92.(canceled)
